(19) United States
(12) Patent Application Publication
(10) Pub. No.: US 2019/0201965 A1
(43) Pub. Date: Jul. 4, 2019

(54) HOT PRESSING METHOD AND HOT PRESSING SYSTEM

(71) Applicant: NIPPON STEEL & SUMITOMO METAL CORPORATION, Tokyo (JP)

(72) Inventor: Kenichiro OTSUKA, Tokyo (JP)

(73) Assignee: NIPPON STEEL & SUMITOMO METAL CORPORATION, Tokyo (JP)

(21) Appl. No.: 16/331,911

(22) PCT Filed: Oct. 4, 2016
(86) PCT No.: PCT/JP2016/079386

§ 371 Date: Mar. 8, 2019

(51) Int. Cl. B21D 37/16; B21D 22/02; B30B 15/34

(52) U.S. Cl. CPC B21D 37/16; B30B 15/34; B21D 22/022

(57) ABSTRACT

In a hot pressing method in which a press-formed product (8 or 9) is manufactured by performing hot pressing on a blank material (7) by using a metal mold (2 or 3) having a punch (21 or 31), a die (22 or 31), and an inner pad (23 or 33) which is biased in a state of projecting toward the die (22 or 32), by making a refrigerant flow through a refrigerant path (233 or 333), a surface temperature T of the inner pad (23 or 33) is cooled to a temperature satisfying the following mathematical expression in which an upper limit is set to 100° C., during a period from when removal of the press-formed product (8 or 9) from the metal mold (2 or 3) is completed to when the next blank material (7) is set in the metal mold (2 or 3), T≤100×(2.3/t)×(h/100)×(λ/30)×(W/2)×S, wherein T: surface temperature of inner pad (23 or 33) (° C.), h: dimension in pressing direction of inner pad (23 or 33) (mm), t: thickness of blank material (7) (mm), λ: thermal conductivity of inner pad (23 or 33) (W/mK), W: volume ratio of refrigerant path inside inner pad (23 or 33) (mm³/mm³), S: flow rate of refrigerant in refrigerant path (233 or 333) (mm/sec).

### TECHNICAL FIELD

The present invention relates to a hot pressing method and a hot pressing system which executes this hot pressing method.

### BACKGROUND ART

For example, a structural member for automobile is required to realize a reduction in weight while maintaining or improving mechanical strength from a viewpoint of improvement in fuel consumption and a viewpoint of protection of passengers. Generally, a material having high mechanical strength has low formability when being subjected to forming work such as presswork, and thus it is difficult to be worked into a complicated shape. As a working method for realizing the improvement in formability of the material having high mechanical strength, there can be cited a so-called hot pressing method (which is sometimes referred to as a hot stamping method, a hot pressing method, a die-quenching method, or the like as well) in which a heated material (a blank material or a pre-press-formed product) is formed in a press forming die and quenched, as described in Patent Literature 1 and Patent Literature 2. With the use of the hot pressing method, since the material is softened at a high temperature when being formed, it has excellent formability, and since the material is quenched and hardened in the press forming die, it is possible to obtain a press-formed product having high mechanical strength.

However, even if the hot pressing method is used, a crack sometimes occurs in a press-formed product. In order to prevent a crack in a press-formed product, Patent Literature 3 discloses a manufacturing method of a cold press-formed product of a member having a cross section in a hat shape which is curved in a planar view based on a line of sight orthogonal to a top plate. Patent Literature 4 discloses a method in which when forming a member having a cross section in a hat shape through hot press forming, an arc-shaped separately-operating punch is built in a metal mold (punch) and the separately-operating punch is made to operate at a forming bottom dead center. Patent Literature 5 discloses a hot press forming method performed by drawing in which formability is improved by cooling a specific portion of a material by using a cooling catalyst in a forming step. However, if the method described in Patent Literature 3 is applied to the hot pressing method, a crack sometimes occurs at a punch shoulder portion. Further, in the method described in Patent Literature 4, it is not possible to suppress a crack in a vertical wall portion that occurs until when the punch reaches the forming bottom dead center.

Further, in a press forming using a pair of metal molds, a method of supporting a blank material by using an inner pad provided in the metal mold is sometimes used. For example, Patent Literatures 5 to 7 disclose a configuration in which a blank material is pressed by an inner pad provided to a metal mold when performing press forming. However, such an inner pad has a volume smaller than that of a main body of the metal mold, so that a temperature thereof is likely to increase. Further, when the hot press forming is performed under a state where the temperature of the inner pad is increased, there is a case where the degree of hardening of a press-formed product to be manufactured is lowered and the mechanical strength is lowered. In particular, when the hot press forming is repeated to manufacture a plurality of press-formed products, since the inner pad is maintained in a state where the temperature thereof is increased, the mechanical strength of press-formed products to be manufactured is sometimes lowered.

### CITATION LIST

### Patent Literature

Patent Literature 1: Specification of British Patent No. 1490535

Patent Literature 2: Japanese Laid-open Patent Publication No. 10-96031

Patent Literature 3: International Publication Pamphlet No. WO 2014-106932

Patent Literature 4: Japanese Laid-open Patent Publication No. 2015-20175

Patent Literature 5: Japanese Laid-open Patent Publication No. 57-31417

Patent Literature 6: Japanese Laid-open Patent Publication No. 2010-149184

Patent Literature 7: Japanese Utility Model Application Publication No. H5-84418

### SUMMARY OF INVENTION

### Technical Problem

In view of the above-described actual circumstances, a problem to be solved by the present invention is to provide a hot pressing method and a hot pressing system capable of suppressing a crack in a press-formed product and realizing improvement of strength of the press-formed product.

### Solution to Problem

As a result of earnest studies, the present inventor came up with various examples of the invention to be described below.

(1)

A hot pressing method, comprising

manufacturing a press-formed product by performing hot pressing on a blank material by using a metal mold having an upper die, a lower die, and an inner pad which is housed in the lower die in a movable manner and biased in a state of projecting toward the upper die, wherein:

a refrigerant path is provided inside the inner pad; and

by making a refrigerant flow through the refrigerant path, a surface temperature of the inner pad is cooled to a temperature satisfying the following mathematical expression in which an upper limit is set to 100° C., during a period from when removal of the press-formed product from the metal mold is completed to when the next blank material is set in the metal mold,

T≤100×(2.3/t)×(h/100)×(λ/30)×(W/2)×S

wherein

T: surface temperature of inner pad (C)

h: dimension in pressing direction of inner pad (mm)

t: thickness of blank material (mm)

λ: thermal conductivity of inner pad (W/mK)

W: volume ratio of refrigerant path inside inner pad (mm³/mm³)

S: flow rate of refrigerant in refrigerant path (mm/sec).

(2)

The hot pressing method according to (1), wherein

a period of time from when the removal of the press-formed product from the metal mold is completed to when the next blank material is set in the metal mold is set to a period of time satisfying the following mathematical expression in which a lower limit is set to five seconds,

A≥5×(t/2.3)×(100/h)×(30/λ)×(2/W)×(1/s)

wherein

A: period of time from when removal of press-formed product from metal mold is completed to when next blank material is set in metal mold (sec)

h: dimension in pressing direction of inner pad (mm)

t: thickness of blank material (mm)

λ: thermal conductivity of inner pad (W/mK)

W: volume ratio of refrigerant path inside inner pad (mm³/mm³)

S: flow rate of refrigerant in refrigerant path (mm/sec).

(3)

The hot pressing method according to (1) or (2), wherein

a dimension in a pressing direction of the inner pad satisfies the following mathematical expression in which a lower limit is set to 100 mm,

h≥100×(t/2.3)×(30/λ)×(2/W)×(1/S)

wherein

h: dimension in pressing direction of inner pad (mm)

t: thickness of blank material (mm)

λ: thermal conductivity of inner pad (W/mK)

W: volume ratio of refrigerant path inside inner pad (mm³/mm³)

S: flow rate of refrigerant in refrigerant path (mm/sec).

(4)

The hot pressing method according to any one of (1) to (3), wherein

a fluid refrigerant is jetted to the inner pad to cool the inner pad during the period from when the removal of the press-formed product from the metal mold is completed to when the next blank material is set in the metal mold.

(5)

The hot pressing method according to any one of (1) to (4), wherein:

the upper die is provided with a refrigerant jet hole capable of jetting the refrigerant toward the inner pad; and

during the period from when the removal of the press-formed product from the metal mold is completed to when the next blank material is set in the metal mold, the upper die is approximated to the lower die, and the refrigerant is jetted from the refrigerant jet hole toward the inner pad provided to the lower die to cool the inner pad.

(6)

A hot pressing system, comprising:

a press machine performing hot pressing on a blank material by using a metal mold having an upper die, a lower die, and an inner pad housed in the lower die in a movable manner, biased in a state of projecting toward the upper die, and having a refrigerant path provided therein; and

a cooling control unit controlling supply of a refrigerant which cools the inner pad, wherein

the cooling control unit makes the refrigerant flow through the refrigerant path to cool a surface temperature of the inner pad to a temperature satisfying the following mathematical expression in which an upper limit is set to 100° C., during a period from when removal of a press-formed product from the metal mold is completed to when the next blank material is set in the metal mold,

T≤100×(2.3/t)×(h/100)×(λ/30)×(W/2)×S

wherein

T: surface temperature of inner pad (° C.)

h: dimension in pressing direction of inner pad (mm)

t: thickness of blank material (mm)

λ: thermal conductivity of inner pad (W/mK)

W: volume ratio of refrigerant path inside inner pad (mm³/mm³)

S: flow rate of refrigerant in refrigerant path (mm/sec).

(7)

The hot pressing system according to (6), wherein

a period of time from when the removal of the press-formed product from the metal mold is completed to when the next blank material is set in the metal mold is set to a period of time satisfying the following mathematical expression in which a lower limit is set to five seconds,

A≥5×(t/2.3)×(100/h)×(30/λ)×(2/W)×(1/s)

wherein

A: period of time from when removal of press-formed product from metal mold is completed to when next blank material is set in metal mold (sec)

h: dimension in pressing direction of inner pad (mm)

t: thickness of blank material (mm)

λ: thermal conductivity of inner pad (W/mK)

W: volume ratio of refrigerant path inside inner pad (mm³/mm³)

S: flow rate of refrigerant in refrigerant path (mm/sec).

(8)

The hot pressing system according to (6) or (7), wherein

a dimension in a pressing direction of the inner pad satisfies the following mathematical expression in which a lower limit is set to 100 mm,

h≥100×(t/2.3)×(30/λ)×(2/W)×(1/S)

wherein

h: dimension in pressing direction of inner pad (mm)

t: thickness of blank material (mm)

λ: thermal conductivity of inner pad (W/mK)

W: volume ratio of refrigerant path inside inner pad (mm³/mm³)

S: flow rate of refrigerant in refrigerant path (mm/sec).

(9)

The hot pressing system according to any one of (6) to (8), further comprising

a refrigerant jet part jetting the refrigerant to the inner pad, wherein

the refrigerant jet part jets a fluid refrigerant to the inner pad to cool the inner pad during the period from when the removal of the press-formed product from the metal mold is completed to when the next blank material is set in the metal mold.

(10)

The hot pressing system according to any one of (6) to (9), wherein:

the upper die is provided with a refrigerant jet hole capable of jetting the refrigerant toward the inner pad; and

during the period from when the removal of the press-formed product from the metal mold is completed to when the next blank material is set in the metal mold, the press machine makes the upper die approximate to the lower die, and the cooling control unit jets the refrigerant from the refrigerant jet hole toward the inner pad provided to the lower die to cool the inner pad.

### Advantageous Effects of Invention

According to the present invention, it is possible to realize suppression of a crack in a press-formed product and improvement of strength of the press-formed product.

### BRIEF DESCRIPTION OF DRAWINGS

FIG. 1 is a view schematically illustrating a configuration example of a first press-formed product.

FIG. 2 is a view schematically illustrating a configuration example of a second press-formed product.

FIG. 3A is a sectional view schematically illustrating a configuration example of a first metal mold used for manufacturing the first press-formed product.

FIG. 3B is a perspective view schematically illustrating a configuration example of a punch of the first metal mold used for manufacturing the first press-formed product.

FIG. 4 is a sectional view schematically illustrating a configuration example of a second metal mold used for manufacturing the second press-formed product.

FIG. 5 is a view schematically illustrating a configuration example of a hot pressing system.

FIG. 6 is a view schematically illustrating another configuration example of an inner pad cooling mechanism.

FIG. 7A is a sectional view schematically illustrating a state at a predetermined timing in a hot pressing method using the first metal mold.

FIG. 7B is a sectional view schematically illustrating a state at a predetermined timing in the hot pressing method using the first metal mold.

FIG. 7C is a sectional view schematically illustrating a state at a predetermined timing in the hot pressing method using the first metal mold.

FIG. 7D is a sectional view schematically illustrating a state at a predetermined timing in the hot pressing method using the first metal mold.

FIG. 7E is a sectional view schematically illustrating a state at a predetermined timing in the hot pressing method using the first metal mold.

FIG. 8A is a sectional view schematically illustrating a state at a predetermined timing in a hot pressing method using the second metal mold.

FIG. 8B is a sectional view schematically illustrating a state at a predetermined timing in the hot pressing method using the second metal mold.

FIG. 8C is a sectional view schematically illustrating a state at a predetermined timing in the hot pressing method using the second metal mold.

FIG. 8D is a sectional view schematically illustrating a state at a predetermined timing in the hot pressing method using the second metal mold.

FIG. 8E is a sectional view schematically illustrating a state at a predetermined timing in the hot pressing method using the second metal mold.

FIG. 9 is a sectional view schematically illustrating a configuration example of a metal mold of a first comparative example.

FIG. 10A is a contour diagram obtained by performing numerical analysis of a plate thickness reduction rate when the first press-formed product is manufactured by using the first metal mold.

FIG. 10B is a contour diagram obtained by performing numerical analysis of a plate thickness reduction rate when the first press-formed product is manufactured by using the metal mold of the first comparative example.

FIG. 10C is a contour diagram obtained by performing numerical analysis of temperatures of respective portions when the first press-formed product is manufactured by using the first metal mold.

FIG. 10D is a contour diagram obtained by performing numerical analysis of temperatures of respective portions when the first press-formed product is manufactured by using the metal mold of the first comparative example.

FIG. 11 is a view schematically illustrating a configuration example of a metal mold of a second comparative example.

FIG. 12A is a contour diagram obtained by performing numerical analysis of a plate thickness reduction rate when the second press-formed product is manufactured by using the second metal mold.

FIG. 12B is a contour diagram obtained by performing numerical analysis of a plate thickness reduction rate when the second press-formed product is manufactured by using the metal mold of the second comparative example.

FIG. 12C is a contour diagram obtained by performing numerical analysis of temperatures of respective portions when the second press-formed product is manufactured by using the second metal mold.

FIG. 12D is a contour diagram obtained by performing numerical analysis of temperatures of respective portions when the second press-formed product is manufactured by using the metal mold of the second comparative example.

FIG. 13 is a graph illustrating a relationship between a surface temperature T of an inner pad top portion at a timing of setting a blank material in a metal mold and mechanical strength of a portion which was brought into contact with the inner pad top portion, of a manufactured press-formed product.

FIG. 14 is a graph illustrating a relationship between a waiting time A and the surface temperature T of the inner pad top portion.

FIG. 15 is a graph illustrating a relationship between a dimension h in a pressing direction of the inner pad and the surface temperature T of the inner pad top portion.

### DESCRIPTION OF EMBODIMENTS

Hereinafter, embodiments of the present invention will be described in detail while referring to the drawings. In the embodiments of the present invention, an example of manufacturing a first press-formed product by using a first metal mold and an example of manufacturing a second press-formed product by using a second metal mold will be described. For the convenience of explanation, it is set that when description is made simply as “metal mold”, this implies both of “first metal mold” and “second metal mold”, and when description is made as “press-formed product”, this implies both of “first press-formed product” and “second press-formed product”. Further, in the embodiments of the present invention, one press-formed product is manufactured through one time of a hot press forming cycle, and a plurality of press-formed products are continuously manufactured by repeating the hot press forming cycles. Further, in the respective drawings, a pressing direction is indicated by an arrow mark P. Note that the pressing direction P is set to indicate a relative moving direction between an upper die and a lower die when performing hot press forming, and is set to a longitudinal direction in the embodiments of the present invention.

<Press-Formed Product>

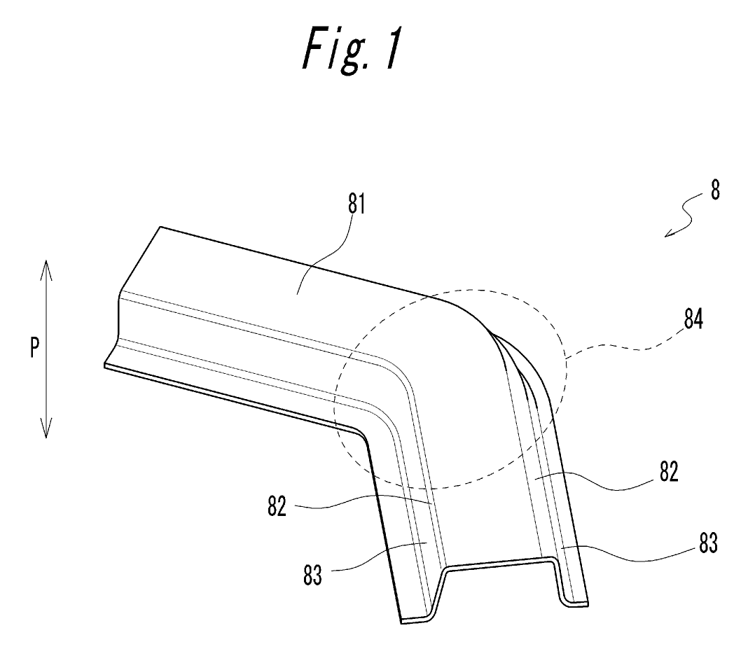

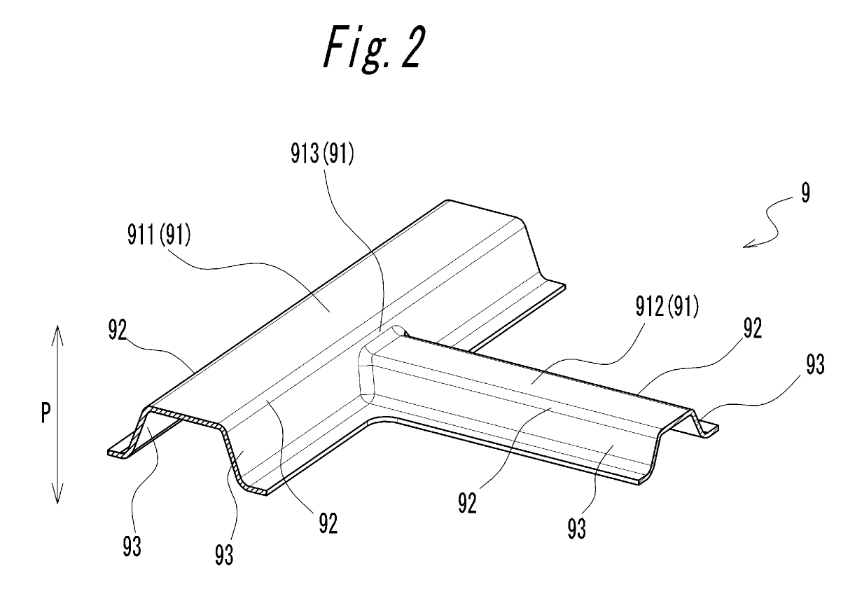

First, configuration examples of press-formed products 8, 9 manufactured by a hot pressing method according to the embodiment of the present invention will be described. As the press-formed products 8, 9 manufactured by the hot pressing method according to the embodiment of the present invention, a first press-formed product 8 illustrated in FIG. 1 and a second press-formed product 9 illustrated in FIG. 2 are exemplified. Each of the first press-formed product 8 and the second press-formed product 9 is manufactured by performing hot press forming on a steel plate being a blank material 7. As the blank material 7, a steel plate having a carbon amount of 0.09 to 0.50%, preferably 0.11% or more in terms of mass % regarding hardenability, and a thickness in a range of 0.6 to 3.2 mm, preferably about 2.3 mm, is employed.

As illustrated in FIG. 1 and FIG. 2, each of the press-formed products 8, 9 has a hat-shaped part. The hat-shaped part has a top plate portion 81 or 91, two edge line portions 82 or 92 formed continuously on both sides of the top plate portion 81 or 91, and two vertical wall portions 83 or 93 formed continuously from the respective two edge line portions. The top plate portion 81 or 91 is a plate-shaped portion extending in a direction which is substantially orthogonal to the pressing direction P, for example. The edge line portions 82 or 92 are portions which are curved or bent at a predetermined curvature. The vertical wall portions 83 or 93 are portions which are inclined at a predetermined angle with respect to the pressing direction P or parallel to the pressing direction P.

Besides, as illustrated in FIG. 1, the first press-formed product 8 has a curved portion 84 curved or bent so as to project in a predetermined direction when viewed in the pressing direction, the curved portion 84 being provided to at least one of the two edge line portions 82 and at least one of the two vertical wall portions 83. Further, as illustrated in FIG. 2, the top plate portion 91 of the second press-formed product 9 has portions whose positions in a height direction (positions in the pressing direction) are mutually different. Further, the portion with higher height of the top plate portion 91 (referred to as “high top plate portion 911”, hereinafter) and a portion with lower height of the top plate portion 91 (referred to as “low top plate portion 912”, hereinafter) are demarcated by a top plate stepped portion 913 being a portion in a stepped shape.

Note that each of the press-formed products 8, 9 illustrated in FIG. 1 and FIG. 2 is an example of the press-formed product manufactured by the hot pressing method according to the embodiment of the present invention. The press-formed products manufactured by the hot pressing method according to the embodiment of the present invention are not limited to have the shapes illustrated in FIG. 1 and FIG. 2.

<Metal Mold>

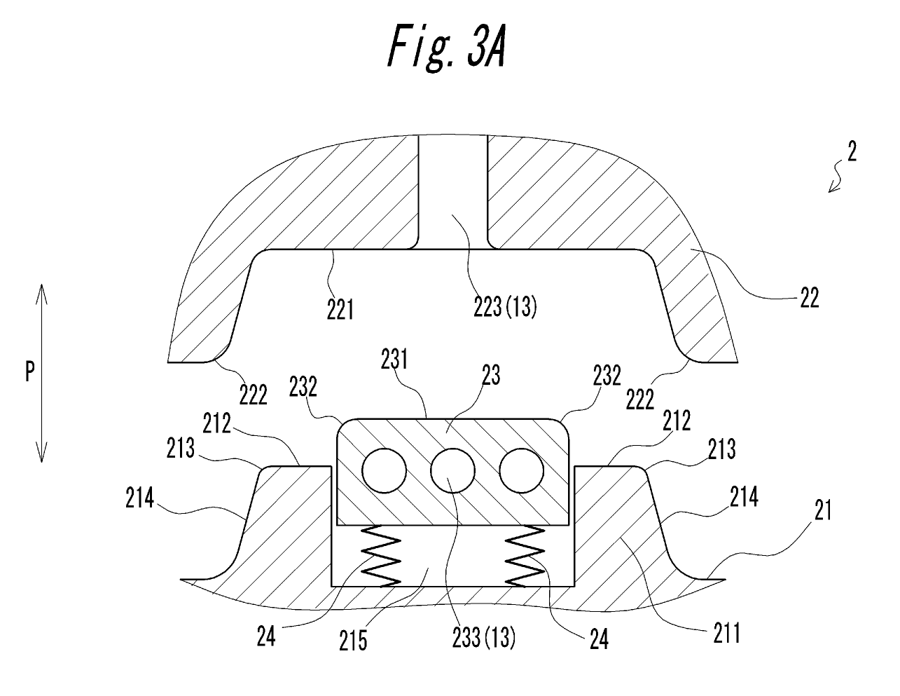

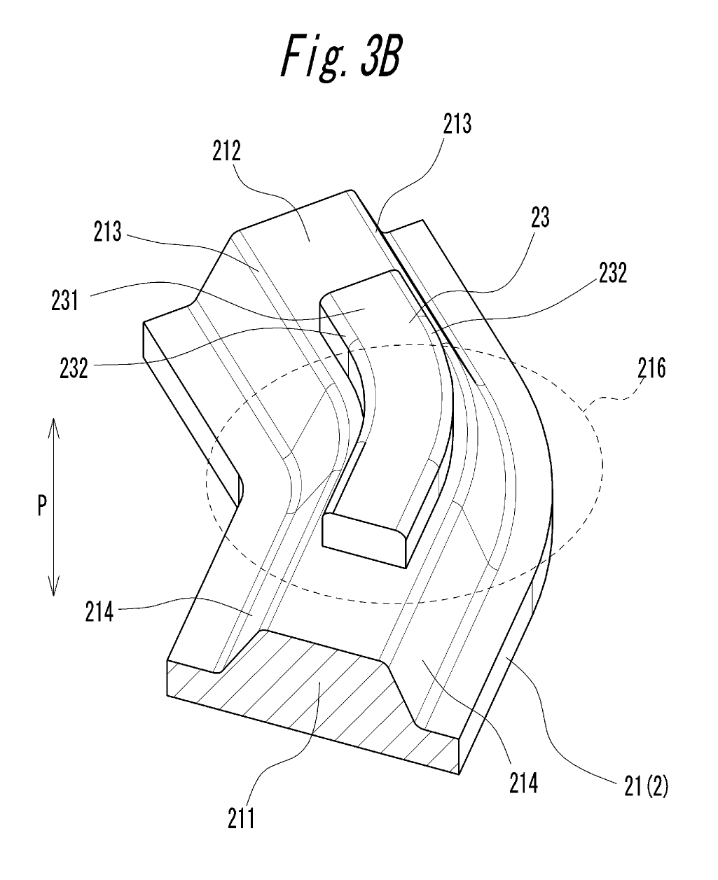

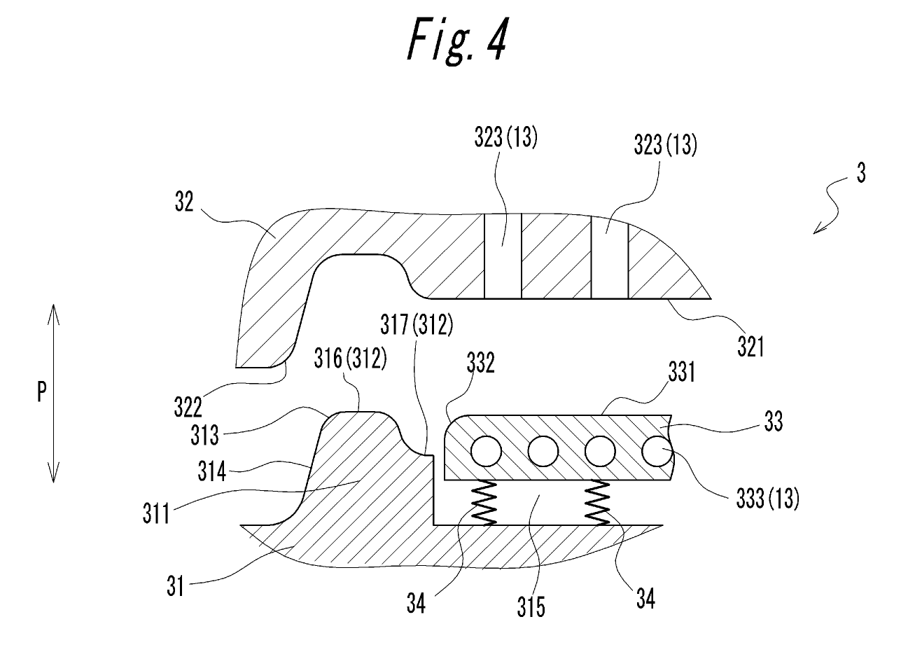

Next, a configuration example of metal molds 2, 3 used in the hot pressing method according to the embodiment of the present invention will be described while referring to FIG. 3A to FIG. 4. FIG. 3A is a sectional view schematically illustrating a configuration example of a first metal mold 2 used for manufacturing the first press-formed product 8, and a sectional view in which a punch curved portion 216 that forms the curved portion 84 is cut at a surface orthogonal to the longitudinal direction of the top plate portion 81. FIG. 3B is a perspective view schematically illustrating a configuration example of a punch 21 of the first metal mold 2, and a view illustrating a portion that forms the curved portion 84. FIG. 4 is a sectional view schematically illustrating a configuration example of the second metal mold 3 used for manufacturing the second press-formed product 9, and a sectional view in which portions that form the high top plate portion 911, the top plate stepped portion 913, and the low top plate portion 912 are cut at a surface parallel to an arranging direction thereof.

As illustrated in FIG. 3A, FIG. 3B, and FIG. 4, the metal mold 2 or 3 has a punch 21 or 31 being a lower die, a die 22 or 32 being an upper die, an inner pad 23 or 33 provided in the punch 21 or 31 in a reciprocally movable manner in the pressing direction P, and a biasing mechanism 24 or 34 biasing the inner pad 23 or 33 toward a side of the die 22 or 32.

The punch 21 or 31 has a punch projecting portion 211 or 311 projecting toward the side of the die 22 or 32, a punch top portion 212 or 312 provided to a tip of the punch projecting portion 211 or 311, two punch shoulder R portions 213 or 313 provided continuously from the punch top portion 212 or 312, and two punch vertical wall portions 214 or 314 provided continuously from the respective two punch shoulder R portions 213 or 313. The punch top portion 212 or 312 is a portion that forms the top plate portion 81 or 91 of the press-formed product 8 or 9, and has a configuration in a shape of flat surface which is substantially orthogonal to the pressing direction P, for example. The punch shoulder R portions 213 or 313 are portions which form the edge line portions 82 or 92 of the press-formed product 8 or 9, and have a configuration in a shape of curved surface having a predetermined radius of curvature. The punch vertical wall portions 214 or 314 are portions that form the vertical wall portions 83 or 93 of the press-formed product 8 or 9, and have a configuration in a shape of flat surface which inclines at a predetermined angle with respect to the pressing direction P or in a shape of flat surface which is parallel to the pressing direction P. Note that concrete shapes of the respective portions of the punches 21, 31 are specified according to the shapes and the like of the press-formed products 8, 9 to be manufactured, and are not limited to the shapes illustrated in FIG. 3A, FIG. 3B, and FIG. 4.

As illustrated in FIG. 3B, in the first metal mold 2, to at least one of the two punch shoulder R portions 213 and at least one of the two punch vertical wall portions 214, the punch curved portion 216 curved or bent so as to project in a predetermined direction when viewed in the pressing direction is provided to form the curved portion 84. Further, as illustrated in FIG. 4, in the second metal mold 3, portions having mutually different heights are provided to the punch top portion 312 for forming the high top plate portion 911 and the low top plate portion 912 with mutually different heights of the top plate portion 91. Concretely, there are provided a high punch top portion 316 whose height is high and which is a portion for forming the high top plate portion 911, and a low punch top portion 317 whose height is low and which is a portion for forming the low top plate portion 912.

As illustrated in FIG. 3A, the punch top portion 212 of the punch 21 of the first metal mold 2 is provided with an inner pad housing hole 215, and in this inner pad housing hole 215, the inner pad 23 being a member separate from the punch 21 is housed in a reciprocally movable manner in the pressing direction P. The inner pad 23 is provided with an inner pad top portion 231 on a side facing the die 22, and inner pad shoulder R portions 232 which are continued from both sides of the inner pad top portion 231. The inner pad shoulder R portions 232 have a configuration in a shape of curved surface having a predetermined radius of curvature.

Further, the inner pad 23 is biased toward the die 22 side by the biasing mechanism 24, and the inner pad top portion 231 and the inner pad shoulder R portions 232 are maintained in a state of projecting by a predetermined dimension on the die 22 side from the punch top portion 212. The projecting dimension of the inner pad 23 is set to a dimension with which when the blank material 7 is placed on the inner pad top portion 231, the blank material 7 is not brought into contact with the punch top portion 212 and the punch shoulder R portions 213. However, the concrete projecting dimension is not particularly limited. Further, when the inner pad 23 is pressed from the die 22 side, it enters inside the inner pad housing hole 215, resulting in that the inner pad top portion 231 and the punch top portion 212 become the same in height. In other words, the inner pad top portion 231 and the punch top portion 212 become flush with each other. In this state, the inner pad top portion 231 becomes a part of the punch top portion 212.

As illustrated in FIG. 4, the punch top portion 312 of the punch 31 of the second metal mold 3 is also provided with an inner pad housing hole 315, and in this inner pad housing hole 315, the inner pad 33 being a member separate from the punch 31 is housed in a reciprocally movable manner in the pressing direction P. Note that in the second metal mold 3, the inner pad housing hole 315 is provided to the low punch top portion 317 (portion that forms the low top plate portion 912). Further, as illustrated in FIG. 4, the high punch top portion 316 and the inner pad 33 are separated by a predetermined distance in a direction orthogonal to the pressing direction P (in a horizontal direction of the sheet of FIG. 4). For example, as illustrated in FIG. 4, the low punch top portion 317 is provided between the high punch top portion 316 and the inner pad 33. This distance is set to a distance at which in a state of placing the blank material 7 on the inner pad top portion 231 and the high punch top portion 316, portions of the blank material 7 to be the top plate stepped portion 913 and the vertical wall portions 93 (in particular, a portion positioned in the vicinity of the top plate stepped portion 913 of the vertical wall portion 93) are not brought into contact with the inner pad 33 and the high punch top portion 316.

Further, also in the second metal mold 3, the inner pad 33 is biased toward the die 32 side by the biasing mechanism 34, and the inner pad top portion 331 is maintained in a state of projecting on the die 32 side from the low punch top portion 317. The projecting dimension is set to a dimension with which when the blank material 7 is placed on the inner pad top portion 331 and the high punch top portion 316, the blank material 7 is not brought into contact with the low punch top portion 317. Further, when the inner pad 33 is pressed from the die 32 side, it enters inside the inner pad housing hole 315, resulting in that the inner pad top portion 331 and the low punch top portion 317 become the same in height. In this state, the inner pad top portion 331 becomes a part of the low punch top portion 317.

Note that the inner pad 23 or 33 is only required to have a configuration capable of supporting a portion of the blank material 7 to be at least a part of the top plate portion 81 or 91 after the hot press forming. In particular, the inner pad 23 or 33 is only required to have a configuration capable of supporting a portion of the blank material 7 to which a tension is applied in a direction orthogonal to the pressing direction P and the vicinity of the portion when performing the hot press forming. Besides, the inner pad 23 or 33 may have a configuration capable of supporting the entire portion of the blank material 7 to be the top plate portion 81 or 91 after the hot press forming. In FIG. 3B, the configuration in which the inner pad 23 is provided to the punch curved portion 216 and the vicinity thereof is illustrated, but, it is also possible to employ a configuration in which the inner pad is provided along the entire length of the punch top portion 212.

Further, the biasing mechanism 24 or 34 is only required to have a configuration capable of biasing the inner pad 23 or 33 toward the side of the die 22 or 32, and a concrete configuration thereof is not limited. As the biasing mechanism 24 or 34, it is possible to employ publicly-known various biasing mechanisms such as, for example, a spring and a gas cushion.

The die 22 or 32 is provided with a die recessed portion 221 or 321 into which the punch projecting portion 211 or 311 can be fitted. To edge portions of the die recessed portion 221 or 321, die shoulder R portions 222 or 322 are provided. The die shoulder R portions 222 or 322 have a configuration in a shape of curved surface having a predetermined radius of curvature. On a bottom portion of the die recessed portion 221 or 321, a refrigerant jet hole 223 or 323 being a refrigerant jet part for jetting a refrigerant toward the inner pad 23 is provided at a position facing the inner pad 23 or 33 which is housed in the inner pad housing hole 215 or 315. The refrigerant jet hole 223 or 323 becomes a part of an inner pad cooling mechanism 13 (to be described later) that cools the inner pad 23 or 33. By jetting a refrigerant such as water or air from the refrigerant jet hole 223 or 323 toward the inner pad 23 or 33, it is possible to cool the inner pad 23 or 33.

<Configuration and Cooling Method of Inner Pad>

Here, detailed configuration example and cooling method of the inner pad 23 or 33 will be described. In the embodiment of the present invention, the blank material 7 heated in a temperature range of 700 to 950° C., preferably about 750° C., is formed by using the metal mold 2 or 3 and cooled, to thereby manufacture the press-formed product 8 or 9. Subsequently, when performing hot press forming, the blank material 7 is formed in a predetermined shape by the punch 21 or 31 and the die 22 or 32 while being supported by the inner pad 23 or 33. For this reason, when performing the hot press forming, a part of the blank material 7 is brought into contact with the inner pad 23 or 33.

In the press-formed product 8 or 9 to be manufactured as described above, in order to set the strength of the portion which was brought into contact with the inner pad 23 or 33 when performing the hot press forming to be 1500 MPa or more, there is a need to set a cooling rate at the portion to be 30° C./sec or more. However, the inner pad 23 or 33 has a volume which is smaller than that of the punch 21 or 31 and the die 22 or 32, so that the temperature thereof is likely to increase when performing the hot press forming. In particular, when a plurality of press-formed products 8 or 9 are continuously manufactured by repeating the hot press forming cycles, the inner pad 23 or 33 is likely to be maintained in a state where the temperature thereof is increased. Further, if the hot press forming is carried out in the state where the temperature of the inner pad 23 or 33 is increased, the cooling rate at the portion which is brought into contact with the inner pad 23 or 33, of the blank material 7 becomes small, resulting in that it becomes impossible to obtain the predetermined strength. Accordingly, in the embodiment of the present invention, the configuration and the cooling method of the inner pad 23 or 33 are set as follows, which makes it possible to increase the cooling rate at the portion which is brought into contact with the inner pad 23 or 33, of the blank material 7, to obtain the predetermined strength.

Although a material of the inner pad 23 or 33 is not particularly limited, it is preferably a material with a thermal conductivity λ of 30 W/mK or more and a specific heat C of 4.3 J/g·K or more. As such a material, it is possible to employ tool steel or the like, for example. Further, as illustrated in FIG. 3A and FIG. 4, a refrigerant path 233 or 333 in a shape of pipeline (namely, a hollow shape) is provided inside the inner pad 23 or 33. The refrigerant path 233 or 333 has a configuration capable of making a fluid refrigerant such as water or air flow therethrough. A volume ratio W of the refrigerant path 233 or 333 (=space volume of refrigerant path 233 or 333 (mm³)/volume of inner pad 23 or 33 (mm³)) is preferably 0.01 to 0.10. Further, a depth from the inner pad top portion 231 or 331 to the refrigerant path 233 or 333 is preferably 10 to 30 mm. With the use of such a configuration, by making the refrigerant flow through the refrigerant path 233 or 333 provided inside the inner pad 23 or 33, it is possible to cool the surface temperature of the inner pad top portion 231 or 331 (namely, the surface temperature of the surface which is brought into contact with the blank material 7) to a predetermined temperature to be described later, during a period from when removal of the press-formed product 8 or 9 from the metal mold 2 or 3 is completed to when the next blank material 7 is set.

Further, as a dimension (height) h in the pressing direction of the inner pad 23 or 33, a dimension satisfying the following mathematical expression (1) in which a lower limit is set to 100 mm is employed,

h≥100×(t/2.3)×(30/λ)×(2/W)×(1/S) Mathematical expression (1)

wherein

h: projecting dimension of inner pad (mm)

t: thickness of blank material (mm)

λ: thermal conductivity of inner pad (W/mK)

W: volume ratio of refrigerant path inside inner pad (mm³/mm³)

S: flow rate of refrigerant in refrigerant path (mm/sec).

Further, although an area of the inner pad top portion 231 or 331 (the surface which is brought into contact with the blank material 7) is specified according to the dimension and the like of the press-formed product 8 or 9 to be manufactured, it is possible to employ a range of 3000 to 20000 mm², for example, and it is possible to employ about 5000 mm² preferably. By specifying the dimension of the inner pad 23 or 33 as described above, it is possible to suppress the increase in temperature of the inner pad 23 or 33 when performing the hot press forming, and suppress the reduction in the cooling rate of the blank material 7. Specifically, if the volume of the inner pad 23 or 33 is small, there is a possibility that the temperature is increased by the heat of the blank material 7 when performing the hot press forming, which reduces the cooling rate of the blank material 7, resulting in that the hardening becomes insufficient. Accordingly, by setting the inner pad 23 or 33 to have such a dimension, if the blank material 7 is one having a thickness of 0.6 to 3.2 mm, for example, it is possible to secure the cooling rate of 30° C./sec or more.

Further, as described above, in order to set the tensile strength of the portion which was brought into contact with the inner pad 23 or 33 when performing the hot press forming to 1500 MPa or more, the cooling rate at the portion has to be set to 30° C./sec or more. For this reason, before starting the hot press forming (namely, at the point of setting the blank material 7 in the metal mold 2 or 3), the refrigerant is made to flow through the refrigerant path 233 or 333 of the inner pad 23 or 33 to perform cooling so that the surface temperature T of the inner pad top portion 231 or 331 becomes the predetermined temperature or less. Concretely, the surface temperature T of the inner pad top portion 231 or 331 before starting the hot press forming is cooled to satisfy the following mathematical expression (2) in which an upper limit is set to 100° C.,

T≤100×(2.3/t)×(h/100)×(λ/30)×(W/2)×S Mathematical expression (2)

wherein

T: surface temperature of inner pad (° C.)

t: thickness of blank material (mm)

h: projecting dimension of inner pad (mm)

λ: thermal conductivity of inner pad (W/mK)

W: volume ratio of refrigerant path inside inner pad (mm³/mm³)

S: flow rate of refrigerant in refrigerant path (mm/sec).

If the surface temperature T of the inner pad top portion 231 or 331 before starting the hot press forming satisfies the aforementioned mathematical expression (2) in which the upper limit is set to 100° C., the tensile strength of the portion which was brought into contact with the inner pad 23 or 33 when performing the hot press forming can be set to 1500 MPa or more.

Further, in order to satisfy the above-described temperature condition when manufacturing a plurality of press-formed products 8 or 9 by repeating the hot press forming cycles, there is a need to provide a period of time for cooling the inner pad 23 or 33 from when the removal of the press-formed product 8 or 9 manufactured by the previous hot press forming from the metal mold 2 or 3 is completed to when the next blank material 7 is set in the metal mold 2 or 3 (referred to as “waiting time A”, hereinafter). In the embodiment of the present invention, this waiting time A is set to a period of time expressed by the following mathematical expression (3) in which a lower limit is set to five seconds,

A≥5×(t/2.3)×(100/h)×(30/λ)×(2/W)×(1/s) Mathematical expression (3)

wherein

A: waiting time (sec)

t: thickness of blank material (mm)

h: dimension in pressing direction of inner pad (mm)

λ: thermal conductivity of inner pad (W/mK)

W: volume ratio of refrigerant path inside inner pad (mm³/mm³)

S: flow rate of refrigerant in refrigerant path (mm/sec).

Accordingly, it is possible to set the surface temperature T of the inner pad top portion 231 or 331 before starting the hot press forming to the aforementioned temperature.

<Hot Pressing System>

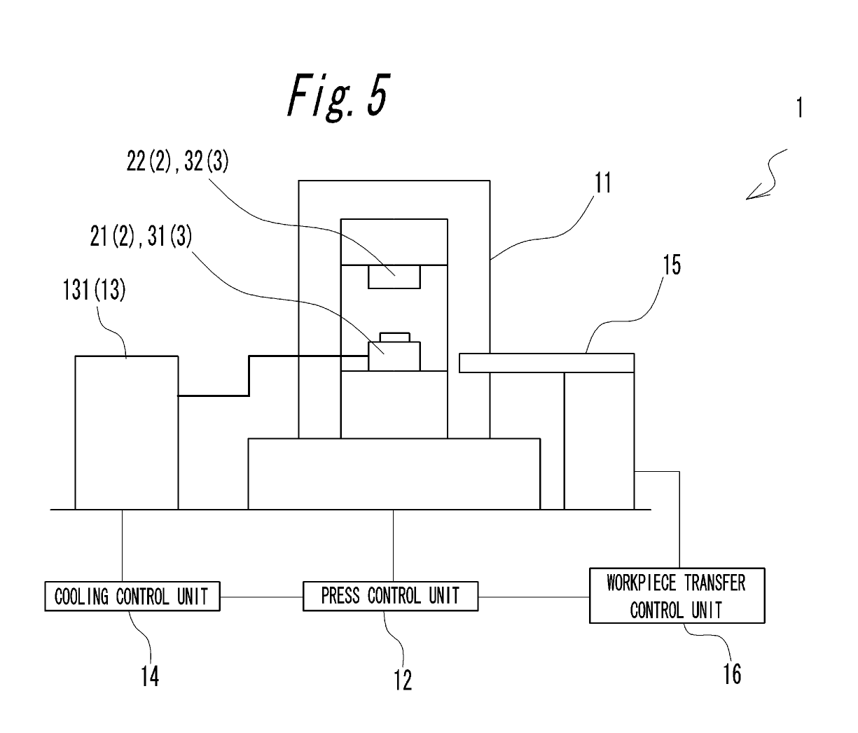

Next, a configuration example of a hot pressing system 1 capable of executing the hot pressing method according to the embodiment of the present invention will be described. FIG. 5 is a view schematically illustrating the configuration example of the hot pressing system 1. As illustrated in FIG. 5, the hot pressing system 1 is configured by including a press machine 11 performing hot press forming on the blank material 7 by using the metal mold 2 or 3, a press control unit 12 controlling the press machine 11, an inner pad cooling mechanism 13 cooling the inner pad 23 or 33, and a cooling control unit 14 controlling the inner pad cooling mechanism 13. As the metal mold 2 or 3 of the press machine 11, the first metal mold 2 is employed when manufacturing the first press-formed product 8, and the second metal mold 3 is employed when manufacturing the second press-formed product 9. Besides, the hot pressing system 1 may also have a workpiece transfer mechanism 15 which performs setting of the blank material 7 in the metal mold 2 or 3 and removal of the formed press-formed product 8 or 9 from the metal mold, and a workpiece transfer control unit 16 controlling the workpiece transfer mechanism 15.

The press machine 11 is only required to have a configuration capable of performing the hot press forming on the blank material 7 by using the metal mold 2 or 3, and a concrete configuration thereof is not particularly limited. As the press machine 11, publicly-known various press machines can be employed. The workpiece transfer mechanism 15 is only required to be able to perform the setting of the blank material 7 in the metal mold 2 or 3 and the removal of the press-formed product 8 or 9 from the metal mold 2 or 3, and a concrete configuration thereof is not particularly limited. For example, as the workpiece transfer mechanism 15, it is possible to employ publicly-known various transfer devices, transfer robots, and the like.

The inner pad cooling mechanism 13 is configured by including the refrigerant path 233 or 333 of the inner pad 23 or 33, the refrigerant jet hole 223 or 323 provided to the die 22 or 32, and a refrigerant supply source 131 which supplies the refrigerant to the refrigerant path 233 or 333 and the refrigerant jet hole 223 or 323. In the embodiment of the present invention, it is possible to employ a fluid such as water or air as the refrigerant. Note that a temperature of the refrigerant may be a normal temperature (room temperature), but, it is also possible to use a refrigerant cooled to a temperature lower than the normal temperature. In this case, the inner pad cooling mechanism 13 further has a refrigerant cooling mechanism which cools the refrigerant. In the embodiment of the present invention, the cooling control unit 14 controls the supply of the refrigerant, to thereby control the cooling of the inner pad 23 or 33. For example, the cooling control unit 14 controls a timing at which the refrigerant is supplied to the refrigerant path 233 or 333 of the inner pad 23 or 33 and a flow rate of the refrigerant, and a timing at which the refrigerant is jetted from the refrigerant jet hole 223 or 323 of the die 22 or 32 and an amount of the refrigerant to be jetted.

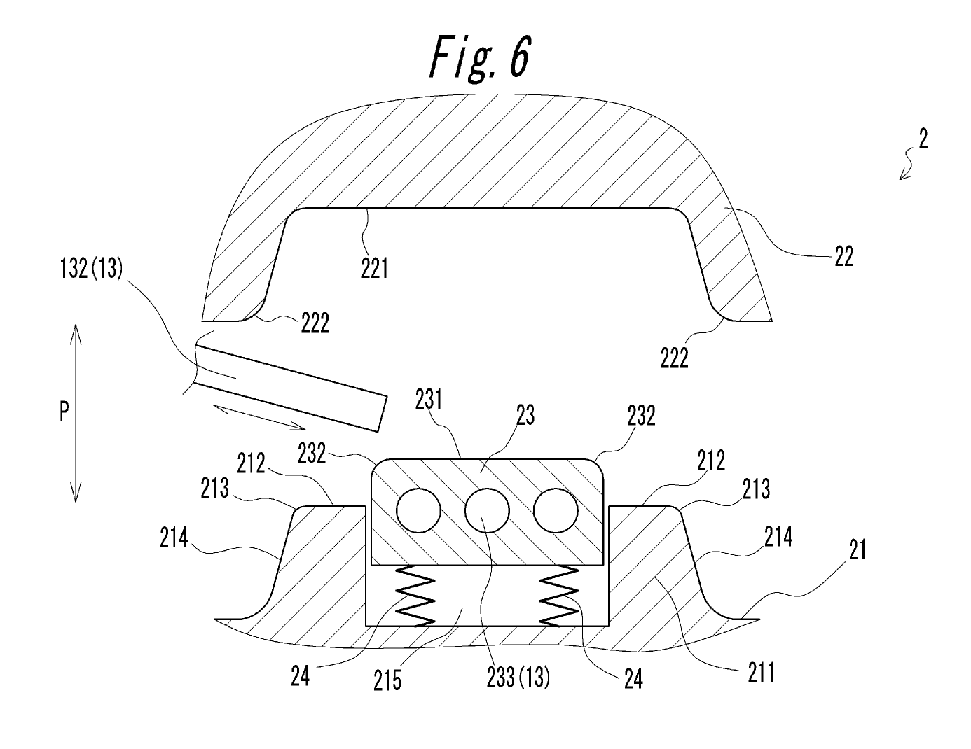

Note that the configuration of the inner pad cooling mechanism 13 is not limited to one in which the refrigerant jet hole 223 or 323 is provided to the die 22 or 32. Here, another configuration example of the inner pad cooling mechanism 13 will be described. FIG. 6 is a diagram schematically illustrating another configuration example of the inner pad cooling mechanism 13. As illustrated in FIG. 6, the inner pad cooling mechanism 13 has a refrigerant jet nozzle 132, in place of the refrigerant jet hole 223 or 323 provided to the die 22 or 32, as a refrigerant jet part which jets the refrigerant. The refrigerant jet nozzle 132 (refrigerant jet part) is provided in the vicinity of the metal mold 2 or 3 so that the refrigerant can be jetted toward the inner pad 23 or 33. In this case, the cooling control unit 14 controls a timing at which the refrigerant is jetted from the refrigerant jet nozzle 132 and a jet amount. Note that a concrete configuration of the refrigerant jet nozzle 132 is not particularly limited, and publicly-known various nozzles can be employed. Further, the refrigerant jet nozzle 132 may also be a movable one capable of being moved by a moving mechanism. In this case, in accordance with the control made by the cooling control unit 14, the moving mechanism makes the refrigerant jet nozzle 132 approximate to the inner pad 23 or 33 at a time of jetting the refrigerant to the inner pad 23 or 33, and makes the refrigerant jet nozzle 132 retract when performing the hot press forming so that the refrigerant jet nozzle 132 does not interfere with the metal mold 2 or 3. As described above, the refrigerant jet part which jets the refrigerant to the inner pad 23 or 33 may be configured to be provided to the metal mold 2 or 3, or configured to be provided separately from the metal mold 2 or 3.

For each of the press control unit 12, the cooling control unit 14, and the workpiece transfer control unit 16, an apparatus having a computer including a CPU, a ROM, and a RAM is employed. In the ROM of the computer of the press control unit 12, a computer program for controlling the press machine is previously stored. Further, the CPU reads the computer program stored in the ROM, and executes the computer program by using the RAM as a work area. Accordingly, the press machine 11 is controlled. The same applies to the cooling control unit 14 and the workpiece transfer control unit 16. Further, when the computers of the press control unit 12, the cooling control unit 14, and the workpiece transfer control unit 16 are cooperated, the hot pressing method according to the embodiment of the present invention is executed.

<Hot Pressing Method>

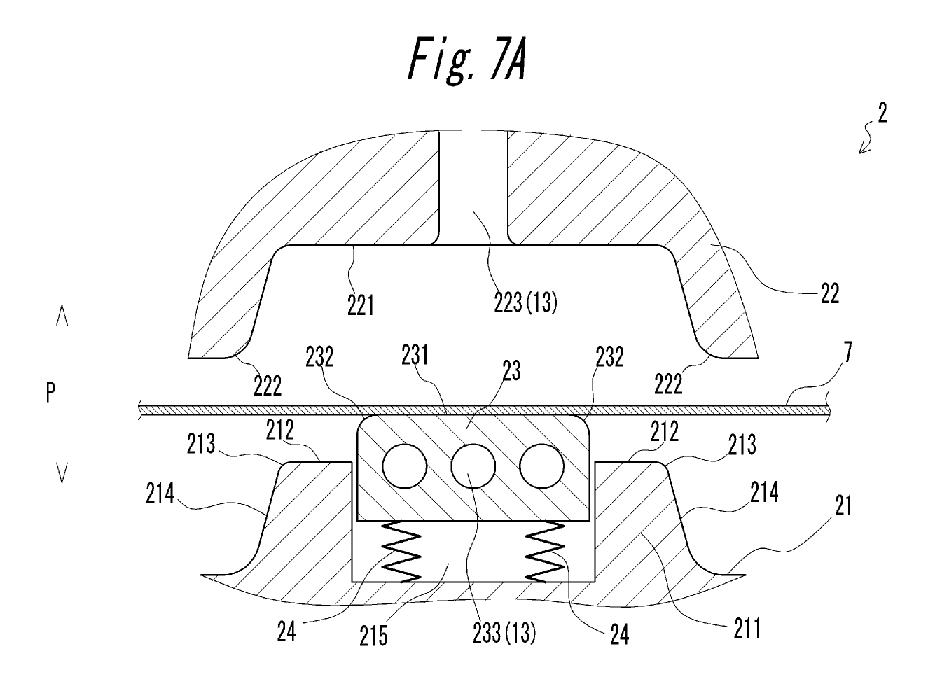

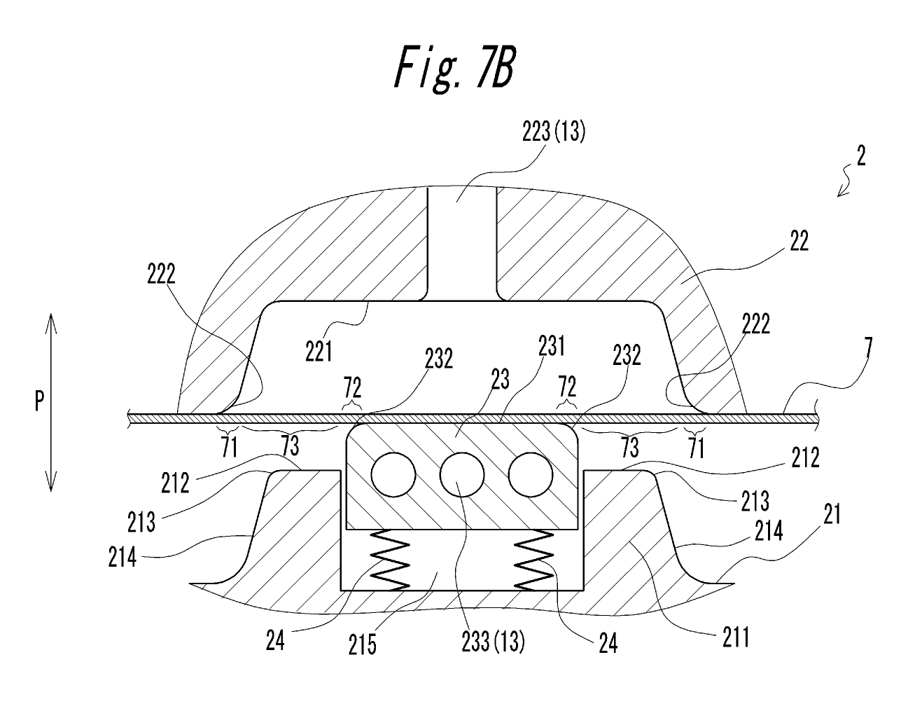

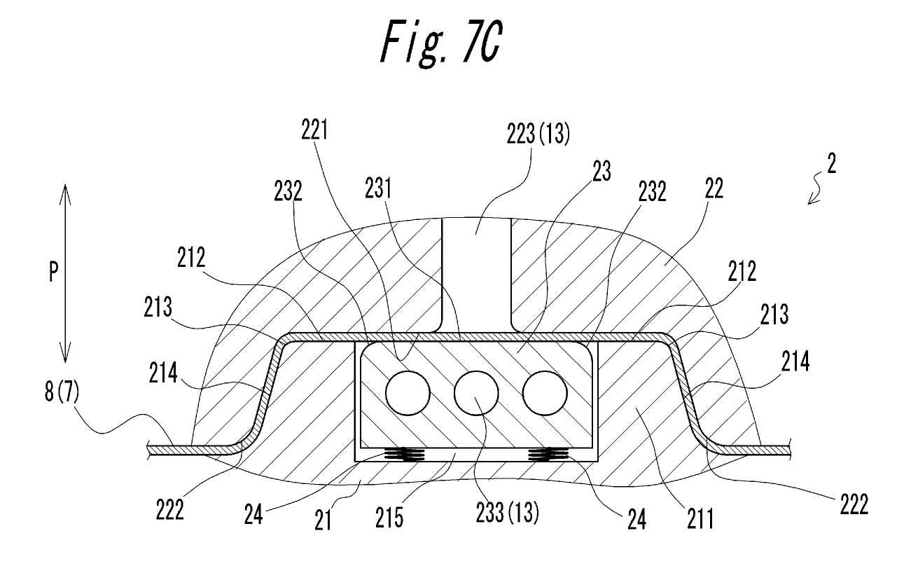

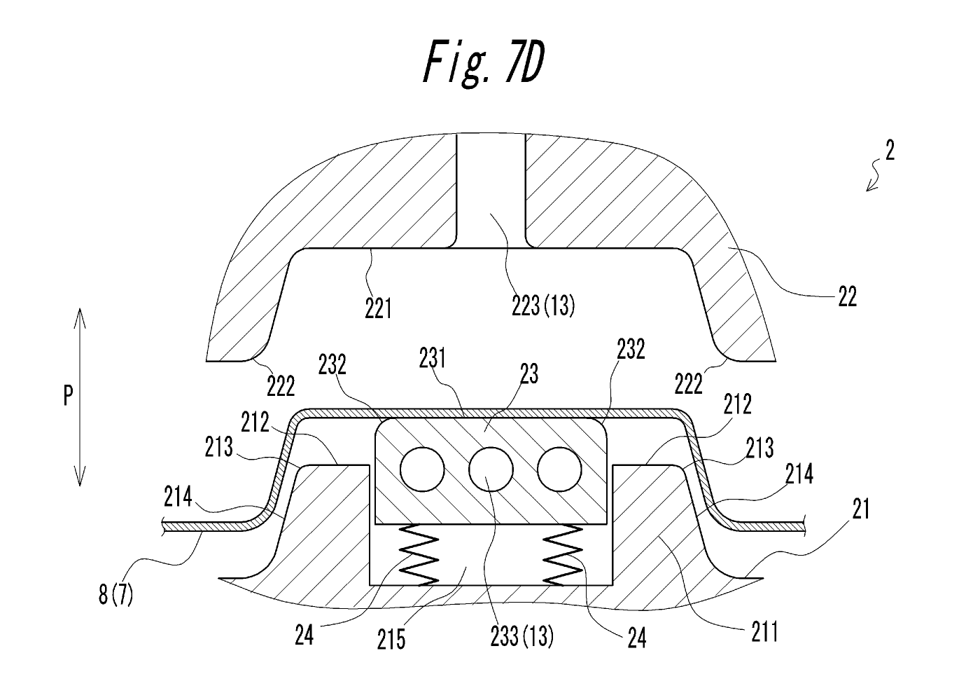

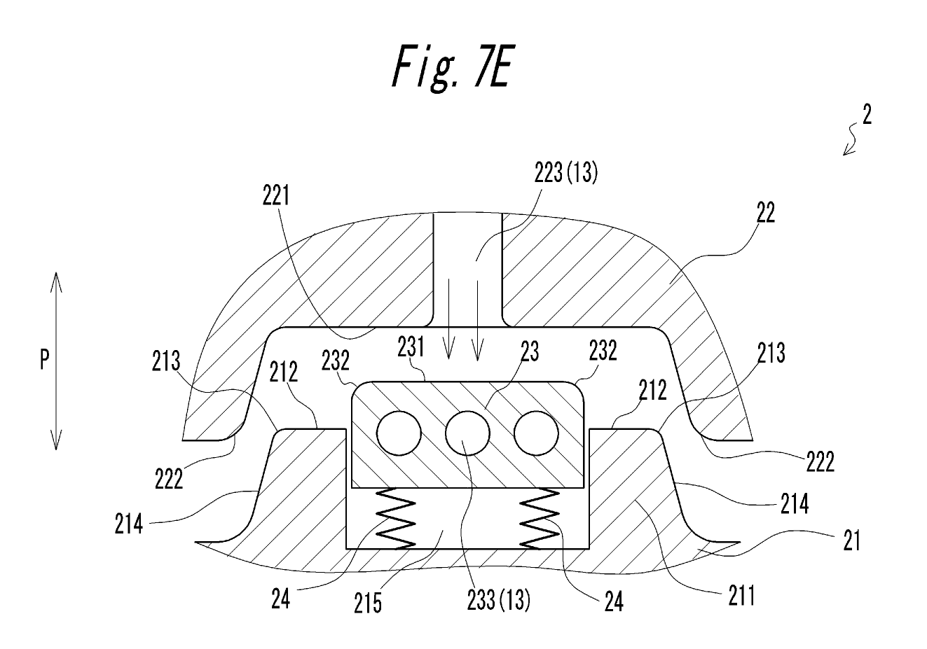

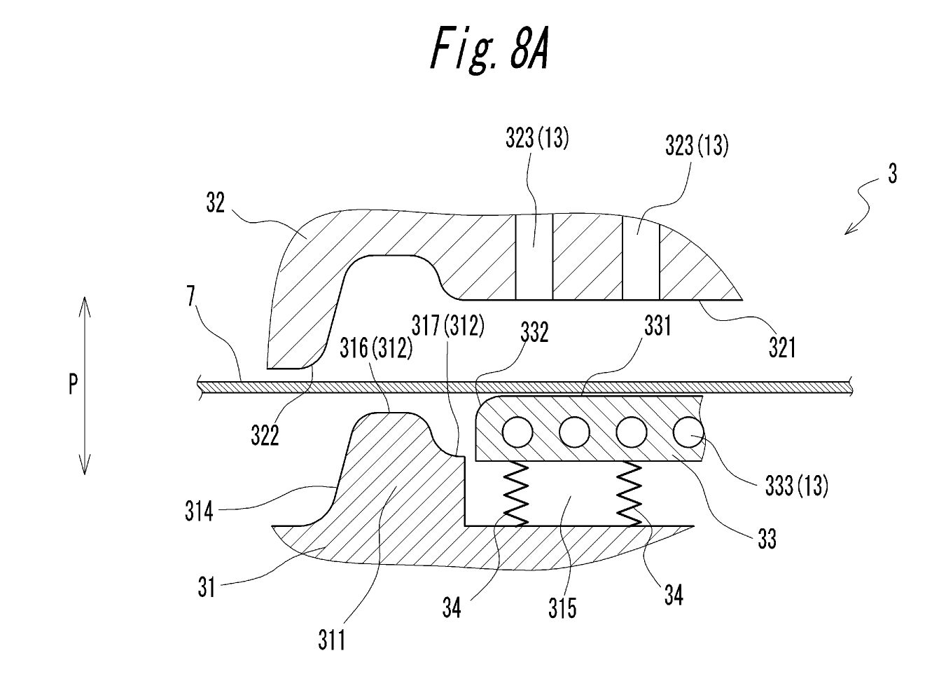

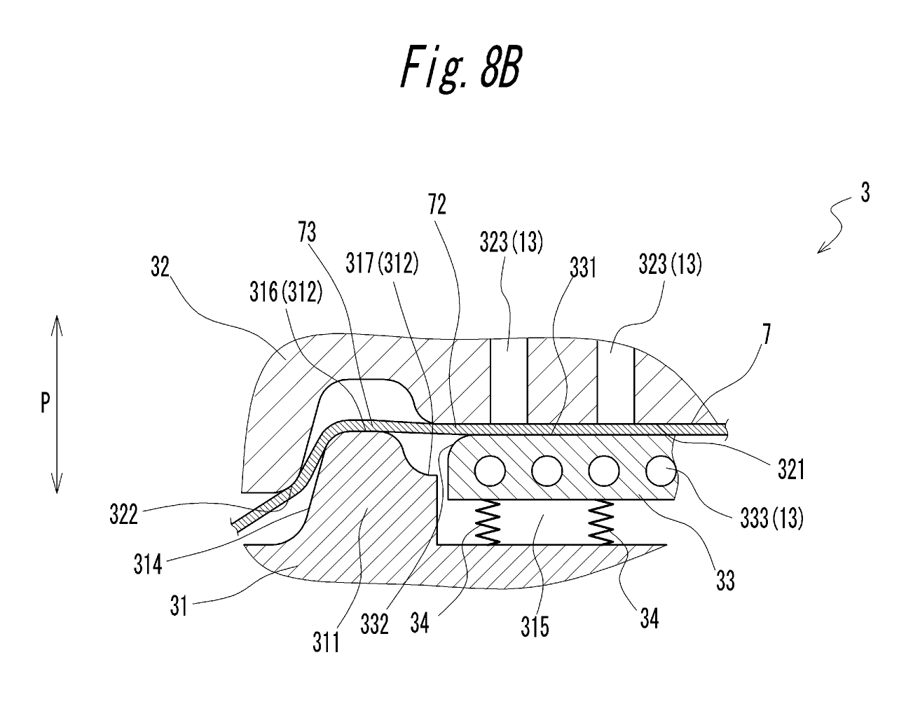

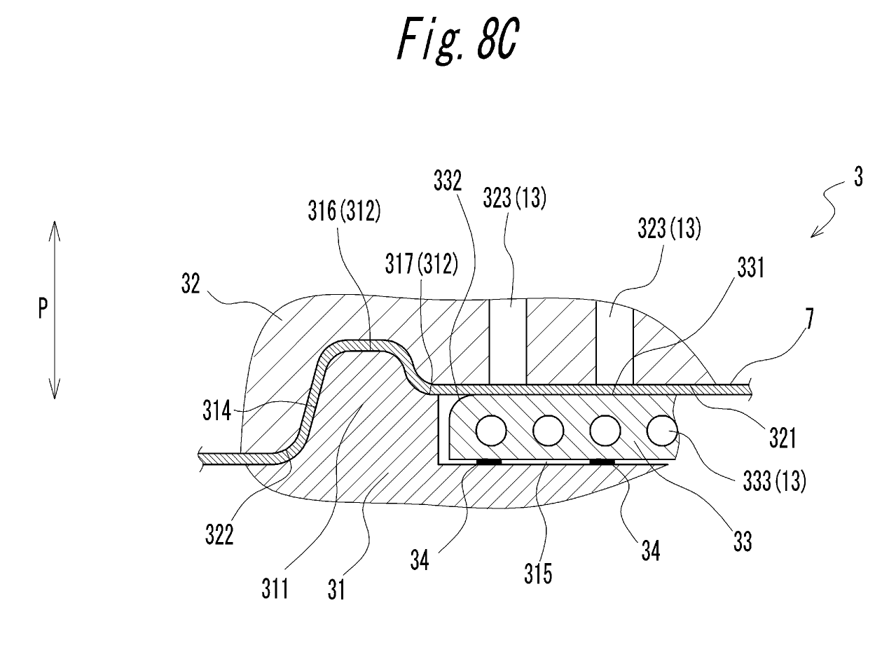

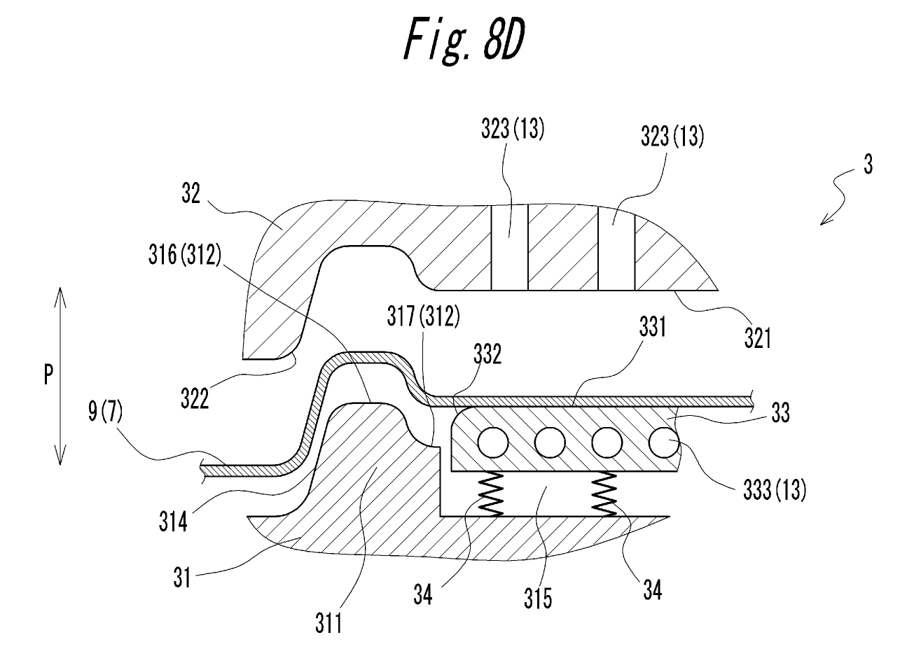

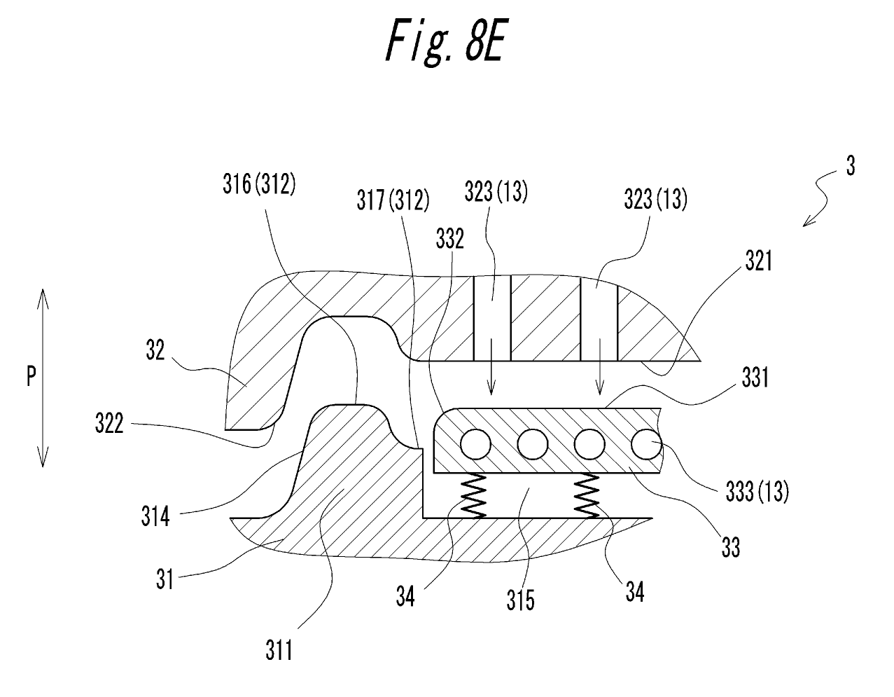

Next, the hot pressing method according to the embodiment of the present invention will be described. FIG. 7A to FIG. 7E are sectional views schematically illustrating the hot pressing method using the first metal mold 2. FIG. 8A to FIG. 8E are sectional views schematically illustrating the hot pressing method using the second metal mold 3.

In the embodiment of the present invention, a temperature of the blank material 7 at a timing at which the blank material 7 is set in the metal mold 2 or 3 is set to fall within a temperature range of 700 to 950° C., and is preferably set to about 750° C. Further, a surface temperature of the metal mold 2 or 3 at the timing at which the blank material 7 is set in the metal mold 2 or 3 is set to 100° C. or less. In particular, the surface temperature T of the inner pad top portion 231 or 331 is set to a temperature satisfying the aforementioned mathematical expression (2) in which the upper limit is set to 100° C., as described above. Accordingly, it is possible to set a cooling rate of the blank material 7 when performing the hot press forming to 30° C./sec or more, and manufacture the press-formed product 8 or 9 having the predetermined mechanical strength.

First, a case of using the first metal mold 2 will be described. As illustrated in FIG. 7A, at a timing before starting the press forming, the inner pad 23 is maintained in a state of projecting by a predetermined dimension from the punch top portion 212 by the biasing mechanism 24. For this reason, at the timing before starting the hot press forming, portions of the blank material 7 set in the first metal mold 2, to be the edge line portions 82 and the vertical wall portions 83 of the first press-formed product 8, are maintained in a state where they are not brought into contact with the punch top portion 212. Accordingly, the reduction in temperature of the portions is prevented or suppressed before starting the hot press forming.

Subsequently, as illustrated in FIG. 7B, the press control unit 12 controls the press machine 11 to make the die 22 approximate to the punch 21. When the die 22 is approximated to the punch 21, the die shoulder R portions 222 are brought into contact with the blank material 7. The portions of the blank material 7 with which the die shoulder R portions 222 are brought into contact are referred to as “die shoulder contacted portions 71”. Note that at a timing right after the die shoulder R portions 222 are brought into contact with the die shoulder contacted portions 71 of the blank material 7, each of portions (referred to as “non-contact portions 73”) between each of portions of the blank material 7 which are brought into contact with the inner pad shoulder R portions 232 (referred to as “inner pad shoulder contacted portions 72”) and each of the die shoulder contacted portions 71, is in a state where it is not brought into contact with both of the punch 21 and the die 22. For this reason, the reduction in temperature of the non-contact portions 73 is prevented or suppressed. Further, by the configuration in which the blank material 7 is supported by the inner pad 23 at a position closer to the die 22 relative to the punch top portion 212, it is possible to increase a distance between each of the die shoulder contacted portions 71 and each of the inner pad shoulder contacted portions 72 of the blank material 7, to thereby increase a range of the non-contact portions 73, namely, a range of the portions where the reduction in temperature is prevented or suppressed.

FIG. 7C illustrates a timing at which the die 22 is positioned at a bottom dead center. When the die 22 is further approximated to the punch 21 from the state of the timing illustrated in FIG. 7B, the non-contact portions 73 of the blank material 7 are pressed against the punch top portion 21 and the punch shoulder R portions 213, as illustrated in FIG. 7C. Further, in accordance with the approximation of the die 22 with respect to the punch 21, the inner pad 23 is pressed, and the projecting dimension of the inner pad 23 from the punch top portion 212 becomes small. When the die 22 reaches the bottom dead center, the inner pad top portion 231 has the same height as the punch top portion 212, and the inner pad top portion 231 becomes a part of the punch top portion 212. Further, the non-contact portions 73 become the edge line portions 82 and the vertical wall portions 83 of the first press-formed product 8, and are cooled to be hardened when they are brought into contact with the punch top portion 212 and the punch shoulder R portions 213. Note that the die shoulder contacted portions 71 of the blank material 7 are cooled to be hardened when they are brought into contact with the die shoulder R portions 222, and the inner pad shoulder contacted portions 72 are cooled to be hardened by being brought into contact with, not the punch shoulder R portions 213 but the inner pad shoulder R portions 232 and the vicinity thereof.

As described above, the inner pad top portion 231 is projected by the predetermined dimension from the punch top portion 212 toward a side close to the die 22 when starting the hot press forming, it is pressed by the die 22 via the blank material 7 in accordance with the approximation of the die 22 with respect to the punch 21, which reduces the projecting dimension, and when the die 22 reaches the bottom dead center, the inner pad top portion 231 becomes a part of the punch top portion 212. Further, in the hot pressing method according to the embodiment of the present invention, the die 22 is approximated to the punch 21 while supporting the blank material 7 by the inner pad 23, thereby manufacturing the first press-formed product 8.

Next, as illustrated in FIG. 7D, the press control unit 12 controls the press machine 11 to move the die 22 to a top dead center. Subsequently, in accordance with the control made by the workpiece transfer control unit 16, the workpiece transfer mechanism 15 removes the manufactured first press-formed product 8 from the first metal mold 2. After that, as illustrated in FIG. 7E, the press control unit 12 controls the press machine 11 to make the die 22 approximate to the punch 21, and in that state, the cooling control unit 14 jets the refrigerant from the refrigerant jet hole 223 provided to the die 22 to cool the inner pad 23. In the embodiment of the present invention, the cooling is performed until the surface temperature T of the inner pad top portion 231 becomes the temperature expressed by the aforementioned mathematical expression (2) in which the upper limit is set to 100° C. By making the die 22 approximate to the inner pad 23 (move from the top dead center to the bottom dead center side) when jetting the refrigerant, it is possible to increase the flow rate of the refrigerant at the surface of the inner pad top portion 231 to reduce the period of time until when the inner pad top portion 231 is cooled to the aforementioned temperature. After the inner pad top portion 231 is cooled, the press control unit 12 controls the press machine 11 to move the die 22 to the top dead center. Consequently, one cycle of the hot press forming is completed.

Subsequently, in accordance with the control made by the workpiece transfer control unit 16, when the waiting time A satisfies the aforementioned mathematical expression (3) in which the lower limit is set to five seconds, the workpiece transfer mechanism 15 sets the next blank material 7 in the first metal mold 2. Accordingly, the next blank material 7 is set in the first metal mold 2 in a state where the surface temperature of the first metal mold 2 is 100° C. or less, particularly, the surface temperature T of the inner pad top portion 231 is cooled to the temperature expressed by the aforementioned mathematical expression (2) in which the upper limit is set to 100° C. Therefore, when the next blank material 7 is subjected to the hot press forming, it is possible to set the cooling rate at the portion which is brought into contact with the inner pad top portion 231 to 30° C./sec or more, resulting in that the first press-formed product 8 having the predetermined strength (which is 1500 MPa or more in this case) can be manufactured.

Next, an example of using the second metal mold 3 will be described. Note that explanation regarding a method same as the method of using the first metal mold 2 will be omitted. FIG. 8A corresponds to FIG. 7A, and illustrates a state of a timing before starting the hot press forming, in which the blank material 7 is set in the second metal mold 3. As illustrated in FIG. 8A, at the timing before starting the hot press forming, the inner pad 33 is maintained in a state of projecting by a predetermined dimension from the low punch top portion 317 toward a side of the die 32 by the biasing mechanism 34. For this reason, at the timing before starting the hot press forming, portions of the blank material 7 set in the second metal mold 3, to be the edge line portions 92 and the vertical wall portions 93 (particularly a portion in close vicinity to the top plate stepped portion 913 of the vertical wall portion 93) of the second press-formed product 9, are maintained in a state where they are not brought into contact with the low punch top portion 317, resulting in that the reduction in temperature before starting the hot press forming is prevented or suppressed.

As illustrated in FIG. 8B, the press control unit 12 controls the press machine 11 to make the die 32 approximate to the punch 31. When the die 32 is approximated to the punch 31, the die shoulder R portion 322 is brought into contact with a predetermined portion (die shoulder contacted portion 71) of the blank material 7. As illustrated in the drawing, the blank material 7 is held by the inner pad top portion 331 and the die 32 before the die 32 reaches the bottom dead center. For this reason, it is possible to draw the blank material positioned at the high punch top portion 316 toward the low punch top portion 317 before the die 32 reaches the bottom dead center. This makes it possible to reduce a tension in a direction orthogonal to the pressing direction P (tension in a horizontal direction of the sheet) generated in the blank material to be formed into the edge line portions 92 and the vertical wall portions 93 of the low top plate portion 912 in the vicinity of the bottom dead center.

FIG. 8C illustrates a timing at which the die 32 is positioned at the bottom dead center. When the die 32 is further approximated to the punch 31 from the state of the timing illustrated in FIG. 8B, and the die 32 reaches the bottom dead center as illustrated in FIG. 8C, the inner pad top portion 331 has the same height as the low punch top portion 317, and the inner pad top portion 331 becomes a part of the low punch top portion 317.

FIG. 8D is a view corresponding to FIG. 7D. As illustrated in FIG. 8D, the press control unit 12 controls the press machine 11 to move the die 32 to the top dead center. Subsequently, in accordance with the control made by the workpiece transfer control unit 16, the workpiece transfer mechanism 15 removes the manufactured second press-formed product 9 from the second metal mold 3.

After that, as illustrated in FIG. 8E (FIG. 8E is a view corresponding to FIG. 7E), the press control unit 12 controls the press machine 11 to make the die 32 approximate to the punch 31 (move from the top dead center to the bottom dead center side), and in that state, the cooling control unit 14 jets the refrigerant from the refrigerant jet hole 323 provided to the die 32 to cool the inner pad 33. The cooling temperature is the same as that in the case of using the first metal mold 2. After the inner pad 33 is cooled, the press control unit 12 controls the press machine 11 to move the die 32 to the top dead center. Consequently, one cycle of the hot press forming is completed.

Subsequently, after the completion of the hot press forming cycle, the next hot press forming cycle is carried out. Note that the waiting time A is the same as that in the case of using the first metal mold 2. With the use of such a method, an effect similar to that of the case of using the first metal mold 2 is exhibited.

<Suppression of Crack Realized by Inner Pad>

Next, a function of suppressing a crack in the press-formed product 8 or 9 obtained by the inner pad 23 or 33 will be described by contrast with an example of using a metal mold 5 or 6 of a comparative example which does not have the inner pad 23 or 33. In a shape such as one of the first press-formed product 8 in which it is formed in a hat shape and having the curved portion 84, a crack is likely to occur in the vertical wall portion 83 on an outer peripheral side of the curved portion 84. Further, in a shape such as one of the second press-formed product 9 in which the top plate stepped portion 913 is provided to the top plate portion 91 in a hat shape, a crack is likely to occur in a portion in close vicinity to the top plate stepped portion 913 of the vertical wall portion 93. These portions have characteristics of the following (i) to (iii).

(i) The tension is applied in not only the pressing direction P but also a direction orthogonal to the pressing direction P during the hot press forming.

(ii) The portion is not brought into contact with the metal mold 2 or 3, so that a temperature thereof is maintained to a high temperature.

(iii) The portion is sandwiched by the die shoulder R portion 222 and the punch shoulder R portion 213 of the metal mold 2 or 3.

Further, in the first press-formed product 8, a strain is concentrated on the vertical wall portion 83 on the outer peripheral side of the curved portion 84 when performing the hot press forming. Further, in the second press-formed product 9, a strain is concentrated on a portion in close vicinity to the top plate stepped portion 913 of the vertical wall portion 93 (the portion at which the height of the top plate portion 91 changes). For this reason, in these portions, the plate thickness reduction rate becomes high, and a crack is likely to occur. Accordingly, in the hot pressing method according to the embodiment of the present invention, by using the inner pad 23 or 33, the range capable of preventing or suppressing the reduction in temperature is increased at the portion of the blank material 7 to be the vertical wall portion 83 on the outer peripheral side of the curved portion 84 and the portion of the blank material 7 to be the portion in close vicinity to the top plate stepped portion 913 of the vertical wall portion 93. Consequently, a local concentration of the strain is suppressed, thereby preventing or suppressing the occurrence of crack.

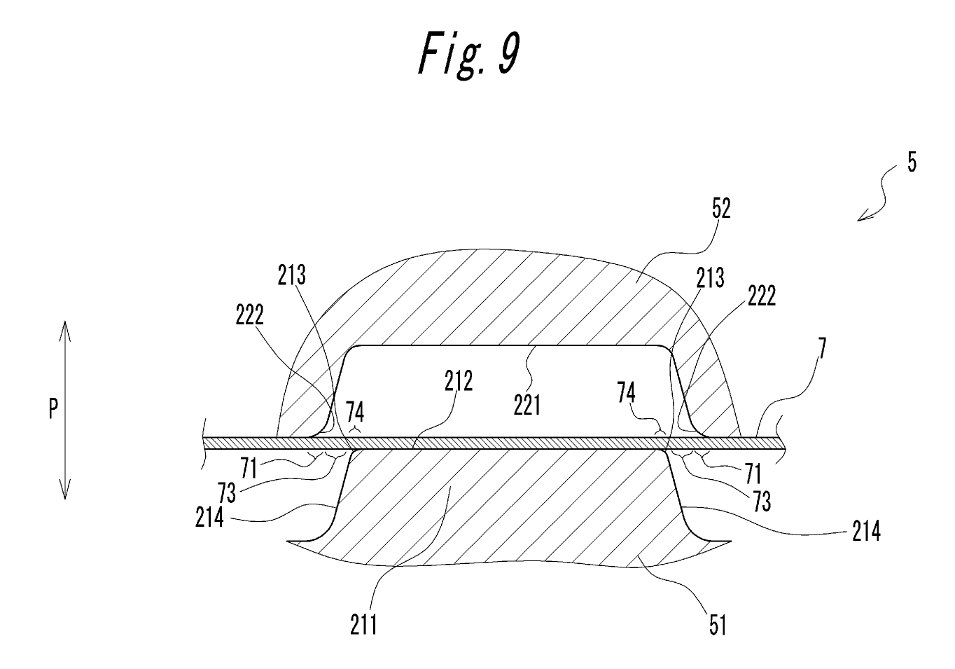

FIG. 9 is a sectional view schematically illustrating a configuration example of a metal mold 5 of a first comparative example, and illustrates a configuration example of a metal mold which does not have the inner pad 23. Note that the same reference numerals are given to configurations common to those of the first metal mold 2, and explanation will be omitted. As illustrated in FIG. 9, a punch 51 of the metal mold 5 of the first comparative example is not provided with the inner pad 23, and the refrigerant jet hole 223 is not provided to a die 52. Other than the above, the configuration same as that of the first metal mold 2 is employed.

When the first press-formed product 8 is manufactured by using the metal mold 5 of the first comparative example which does not have the inner pad 23, the blank material 7 is subjected to hot press forming in a state of being supported by the punch top portion 212. Further, the die shoulder contacted portions 71 of the blank material 7 are cooled by being brought into contact with the die shoulder R portions 222, and the punch shoulder contacted portions 74 (which indicate portions of the blank material 7 which are brought into contact with the punch shoulder R portions 213) are cooled by being brought into contact with the punch shoulder R portions 213. If such a configuration is employed, a range of the non-contact portion 73 between the die shoulder contacted portion 71 and the punch shoulder contacted portion 74 is narrower than that in the method of using the first metal mold 2 having the inner pad 23. Specifically, a range of the portion at which the reduction in temperature is suppressed is narrow. Further, since the strain is concentrated on this small range, the plate thickness reduction rate becomes high, and a crack is likely to occur. Besides, if the configuration in which the curved portion 84 is provided to the first press-formed product 8 is employed, the concentration of the strain on the portion positioned at the curved portion 84 of the vertical wall portion 83 occurs significantly. This is because, when the edge line portions 82 are curved when viewed in the pressing direction, a flow of the blank material 7 becomes non-uniform when performing the hot press forming.

On the contrary, as illustrated in FIG. 7B, in the embodiment of the present invention, the first metal mold 2 having the inner pad 23 is used, and the portion of the blank material 7 to be the top plate portion 81 is supported by the inner pad 23 at a position where it is projected by a predetermined dimension from the punch top portion 212 toward the die 22 side. In this state, when viewed in the pressing direction, a distance between the die shoulder R portion 222 and the inner pad shoulder R portion 232 is larger than a distance between the die shoulder R portion 222 and the punch shoulder R portion 213. If such a configuration is employed, the range of the non-contact portion 73 can be set to be larger than that in the method of using the metal mold 5 of the first comparative example.

Further, while maintaining this state, the punch 21 and the die 22 are made to approximate in a relative manner to perform clamping, thereby manufacturing the first press-formed product 8. At this time, the die shoulder contacted portions 71 of the blank material 7 are cooled by being brought into contact with the die shoulder R portions 222, and the inner pad shoulder contacted portions 72 are cooled by being brought into contact with, not the punch shoulder R portions 213 but the inner pad shoulder R portions 232. With the use of such a configuration, the range of the non-contact portions 73 (namely, the portions where the reduction in temperature is prevented or suppressed) can be increased, so that in the portion of the blank material 7 to be the curved portion 84, the concentration of strain is suppressed when performing the hot press forming. For this reason, the plate thickness reduction rate is reduced, and the occurrence of crack is suppressed.

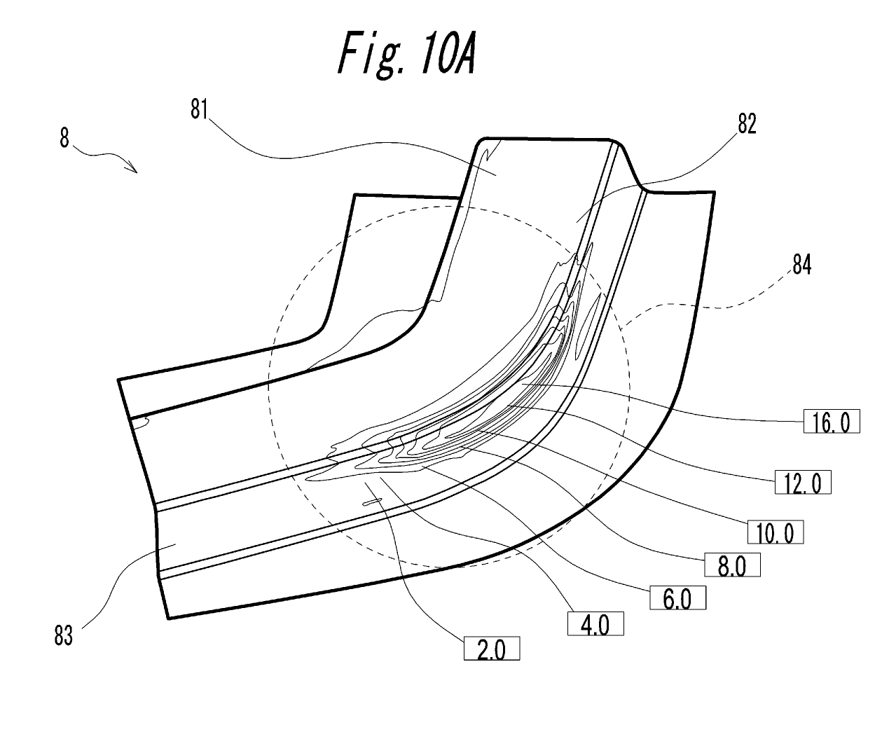

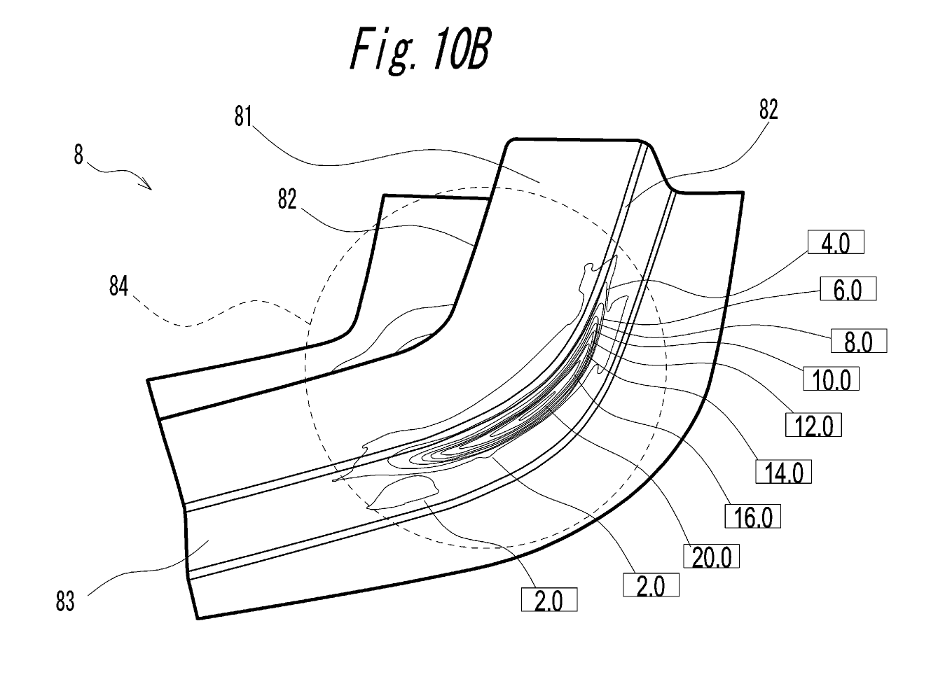

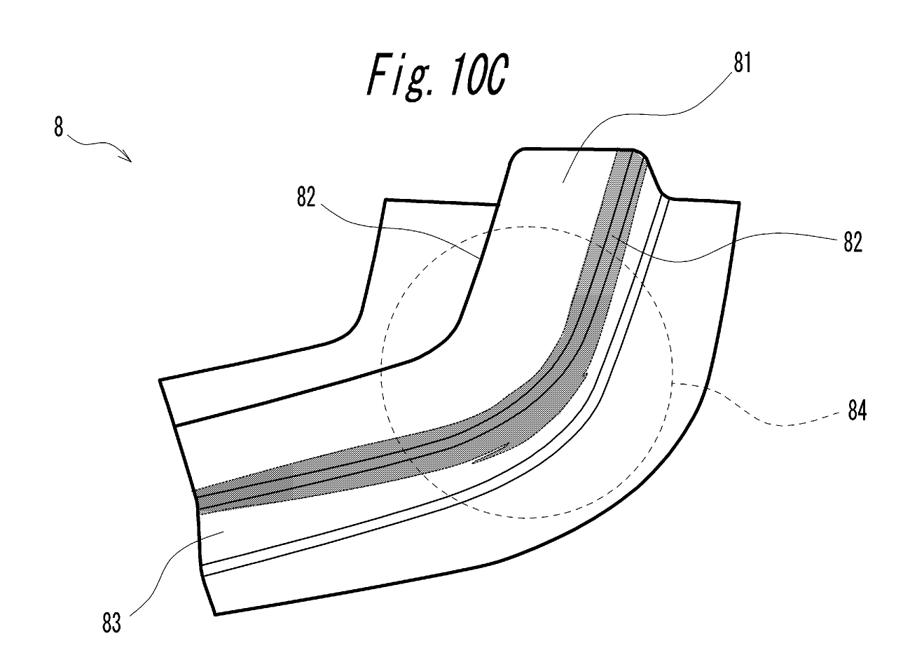

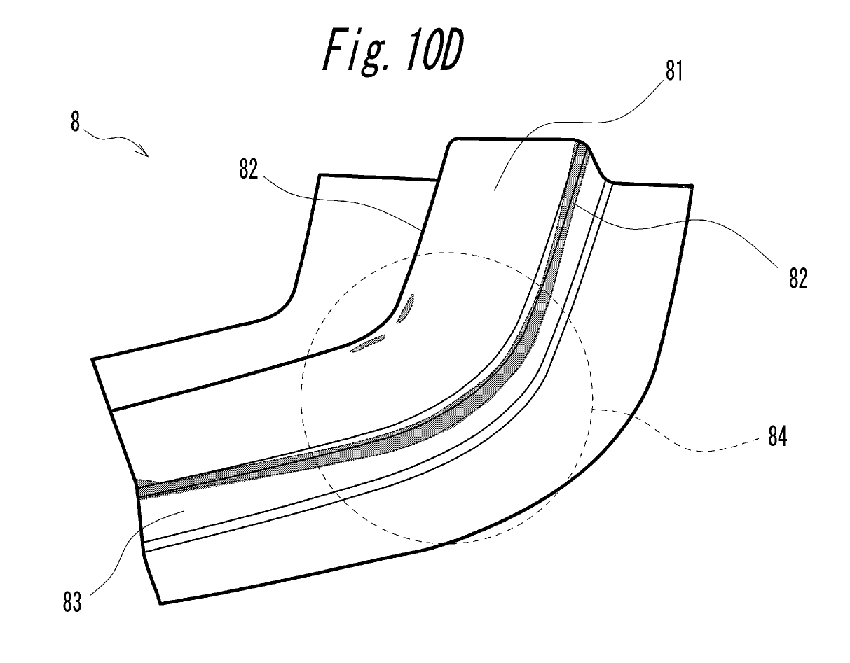

Each of FIG. 10A and FIG. 10B is a contour diagram obtained by performing numerical analysis of a plate thickness reduction rate when the first press-formed product 8 is manufactured. FIG. 10A illustrates a case where the first metal mold 2 is used, and FIG. 10B illustrates a case where the metal mold 5 of the first comparative example is used. Further, a numeric value surrounded by a rectangular frame in the drawing indicates the plate thickness reduction rate. Each of FIG. 10C and FIG. 10D is a contour diagram obtained by performing numerical analysis of temperatures of respective portions when the first press-formed product 8 is manufactured. FIG. 10C illustrates a case where the first metal mold 2 is used, and FIG. 10D illustrates a case where the metal mold 5 of the first comparative example is used. In FIG. 10C and FIG. 10D, a region painted in black solid indicates a region in which a temperature in a state where the die 22 is positioned above the bottom dead center by 10 mm is 650° C. or more.

As is apparent from the comparison between FIG. 10A and FIG. 10B, and between FIG. 10C and FIG. 10D, when the first press-formed product 8 is manufactured by using the hot press forming, the range of the portion where the reduction in temperature is suppressed can be increased at the portion positioned at the curved portion 84 of the vertical wall portion 83 according to the method of using the first metal mold 2, when compared to the method of using the metal mold 5 of the first comparative example. As described above, it is possible to alleviate the local concentration of the strain to suppress the plate thickness reduction rate, resulting in that the occurrence of crack in the curved portion 84 of the vertical wall portion 83 can be prevented or suppressed.

Note that in the embodiment of the present invention, the first press-formed product 8 has the curved portion 84 curved when viewed in the pressing direction, and the method of preventing or suppressing the occurrence of crack in this curved portion 84 is described, but, it is possible to prevent or suppress the occurrence of crack also in a press-formed product having a shape other than the shape as described above. For example, the hot pressing method according to the embodiment of the present invention can also be applied to the manufacture of a press-formed product having edge line portions in a ring shape such as a circular shape, an elliptical shape, or a polygonal shape, and also in the press-formed products having these shapes, it is possible to prevent or suppress the occurrence of crack.

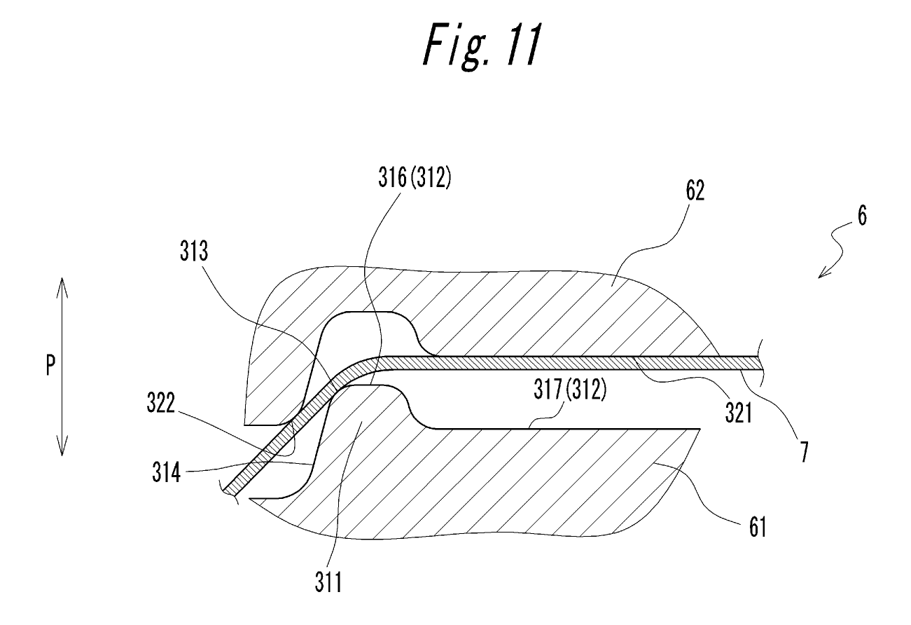

FIG. 11 is a view schematically illustrating a configuration example of a metal mold 6 of a second comparative example, and illustrates an example of a metal mold which does not have the inner pad 33. As illustrated in FIG. 11, a punch 61 of the metal mold 6 of the second comparative example is not provided with the inner pad 33, and the refrigerant jet hole 323 is not provided to a die 62.

As illustrated in FIG. 11, when the metal mold 6 of the second comparative example is used to manufacture the second press-formed product 9, the high punch top portion 316 is brought into contact with the blank material 7 before the low punch top portion 317 is brought into contact with the blank material 7, resulting in that the high top plate portion 911 is formed before the low top plate portion 912 is formed. Further, when the hot press forming proceeds and at a timing at which the low punch top portion 317 is brought into contact with the blank material 7, the blank material 7 is held by the formed high punch top portion 316. For this reason, the inflow of the material with respect to a portion in close vicinity to the top plate stepped portion 913 of the vertical wall portion 93 becomes insufficient, and the tension occurs in the horizontal direction of the sheet, resulting in that a crack is likely to occur in the portion.

In the embodiment of the present invention, by using the second metal mold 3 having the inner pad 33, the range of the portion where the reduction in temperature is prevented or suppressed is increased in the portion to be the vertical wall portion 93 (the portion in close vicinity to the top plate stepped portion 913, in particular). This makes it possible to alleviate the local strain concentration to prevent or suppress the occurrence of crack. Besides, as illustrated in FIG. 8A, the hot press forming is performed while supporting the portion to be the top plate portion 91, the portion to be the top plate stepped portion 913 and the vicinity thereof, of the blank material 7, with the use of the inner pad 33. Consequently, the portion positioned on the upper side of the high punch top portion 316 and the portion positioned on the upper side of the low punch top portion 317, of the blank material 7, are substantially simultaneously formed into the high top plate portion 911 and the low top plate portion 912. Accordingly, it is possible to reduce the tension in the horizontal direction of the sheet which occurs in the non-contact portion 73 when performing the hot press forming.

Further, by the operation of reducing the tension which occurs in the blank material 7 and the operation of increasing the range of the non-contact portion 73 of the blank material 7, the operations being obtained by the inner pad 33, the formability is greatly improved. As described above, by using the second metal mold 3 having the inner pad 33 when manufacturing the second press-formed product 9 provided with the high top plate portion 911 and the low top plate portion 912, it is possible to prevent or suppress the occurrence of crack due to the tension applied in the direction orthogonal to the pressing direction P, in the portion in close vicinity to the top plate stepped portion 913 of the vertical wall portion 93 (the vertical wall portion 93 continued to the low top plate portion 912).

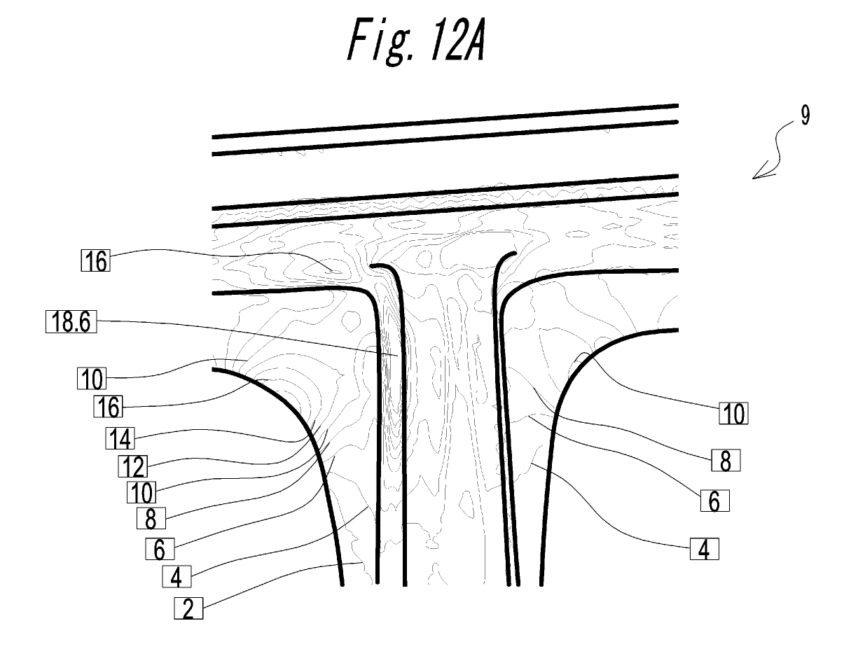

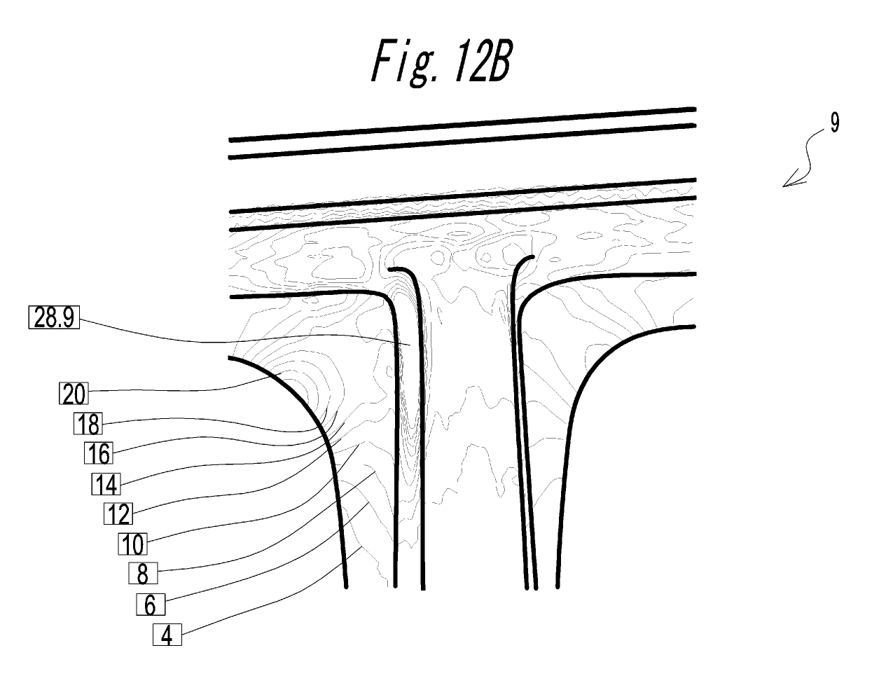

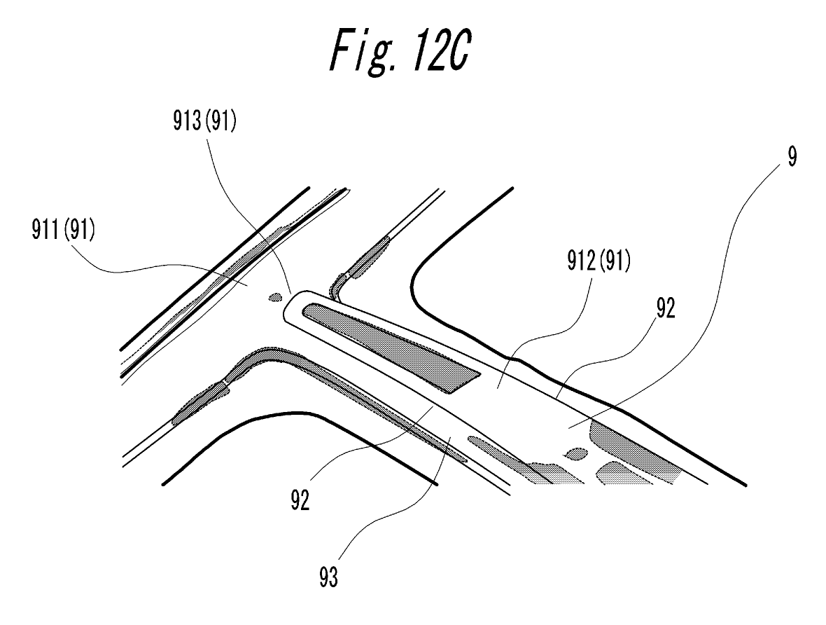

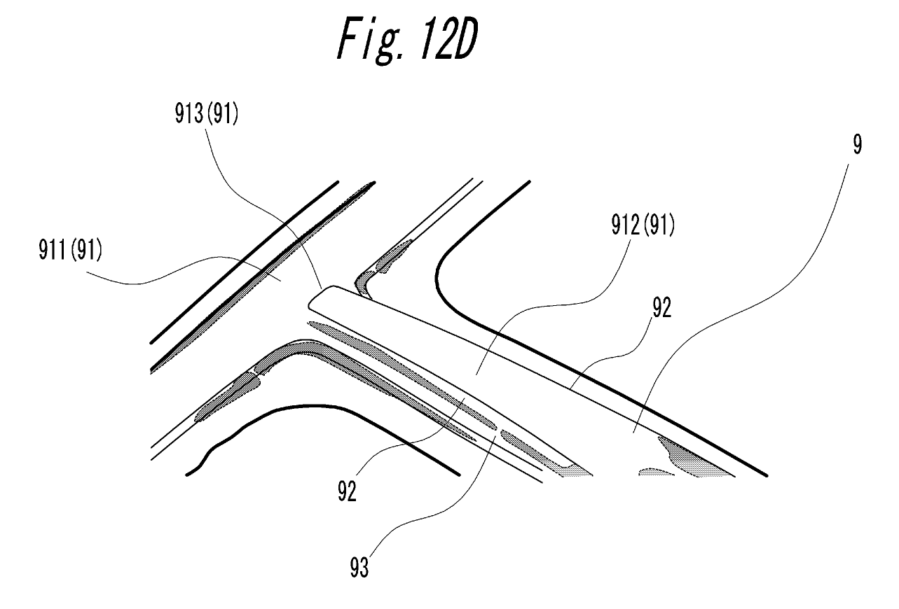

Each of FIG. 12A and FIG. 12B is a contour diagram obtained by performing numerical analysis of a plate thickness reduction rate when the second press-formed product 9 is manufactured. A numeric value surrounded by a rectangular frame in the drawing indicates the plate thickness reduction rate. FIG. 12A illustrates a case where the second metal mold 3 is used, and FIG. 12B illustrates a case where the metal mold 6 of the second comparative example is used. Each of FIG. 12C and FIG. 12D is a view illustrating a region where a temperature is 650° C. or less in a state where the die 32 is positioned above the bottom dead center by 4 mm when the second press-formed product 9 is manufactured. FIG. 12C illustrates a case where the second metal mold 3 is used, and FIG. 12D illustrates a case where the metal mold 6 of the second comparative example is used. Note that a region painted in black solid indicates the region where the temperature is 650° C. or less.

As is apparent from the comparison between FIG. 12A and FIG. 12B, and between FIG. 12C and FIG. 12D, when the second metal mold 3 is used, the range of the non-contact portion 73 of the blank material 7 can be increased, when compared to the case of using the metal mold 6 of the second comparative example, and accordingly, it is possible to alleviate the local concentration of the strain to suppress the increase in the plate thickness reduction rate. Therefore, the occurrence of crack in the portion in close vicinity to the top plate stepped portion 913 of the vertical wall portion 93 can be prevented or suppressed.

### EXAMPLES

Next, examples will be described. In the examples of the present invention, a press-formed product was manufactured by setting a target of the tensile strength to 1500 MPa, and measurements were conducted regarding (1) the surface temperature T of the inner pad top portion 231 or 331 at a timing of setting the blank material 7 in the metal mold 2 or 3, and mechanical strength of a portion which was brought into contact with the inner pad top portion 231 or 331, of the manufactured press-formed product 8 or 9, and (2) a relationship between the waiting time A (a period of time from when the removal of the press-formed product 8 or 9 from the metal mold 2 or 3 is completed to when the next blank material 7 is set) and the surface temperature T of the inner pad top portion 231 or 331.

The measurement conditions are as follows. A contact area between the blank material 7 and the inner pad 23 or 33 is 5000 mm². The dimension h in the pressing direction of the inner pad 23 or 33 is 100 mm. The inner pad 23 or 33 is tool steel, the thermal conductivity λ thereof is 30 W/mK, and a specific heat C thereof is 4.3 J/g·K. The volume ratio W of the refrigerant path 233 or 333 inside the inner pad 23 or 33 is 0.02. The depth from the surface of the inner pad 23 or 33 to the refrigerant path 233 or 333 is 20 mm. As the blank material 7, a plate material of carbon steel with a carbon amount of 0.11% in terms of mass % and a thickness t of 2.3 mm was used. A temperature of the blank material 7 at the point of setting the blank material 7 in the metal mold 2 or 3 was set to 750° C. As the refrigerant, water was used. The flow rate of the refrigerant in the refrigerant path 233 or 333 was set to 1 m/s.

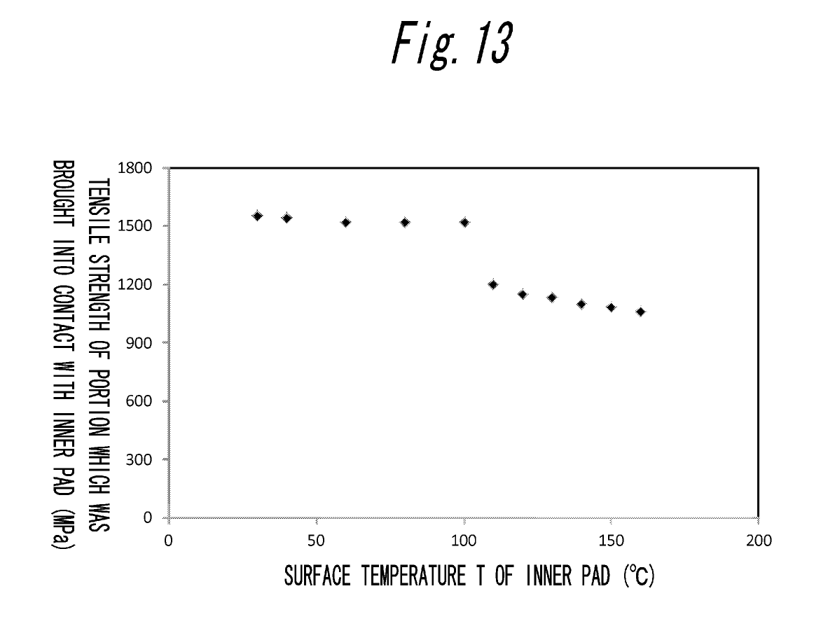

FIG. 13 is a graph illustrating a relationship between the surface temperature T of the inner pad top portion 231 or 331 at a timing of setting the blank material 7 in the metal mold 2 or 3 and the mechanical strength of the portion which was brought into contact with the inner pad top portion 231 or 331, of the manufactured press-formed product 8 or 9. Note that the surface temperature T of the inner pad top portion 231 or 331 is a value calculated by using the aforementioned mathematical expression (2). As illustrated in FIG. 13, it was confirmed that when the surface temperature T of the inner pad top portion 231 or 331 is 100° C. or less at the timing of setting the blank material 7 in the metal mold 2 or 3, the tensile strength of the portion which was brought into contact with the inner pad top portion 231 or 331 when performing the hot press forming becomes 1500 MPa or more. Since the tensile strength became high rapidly in the vicinity of 100° C., in particular, it was confirmed that it is preferable to satisfy the aforementioned mathematical expression (2) in which the upper limit of the surface temperature T of the inner pad top portion 231 or 331 is set to 100° C.

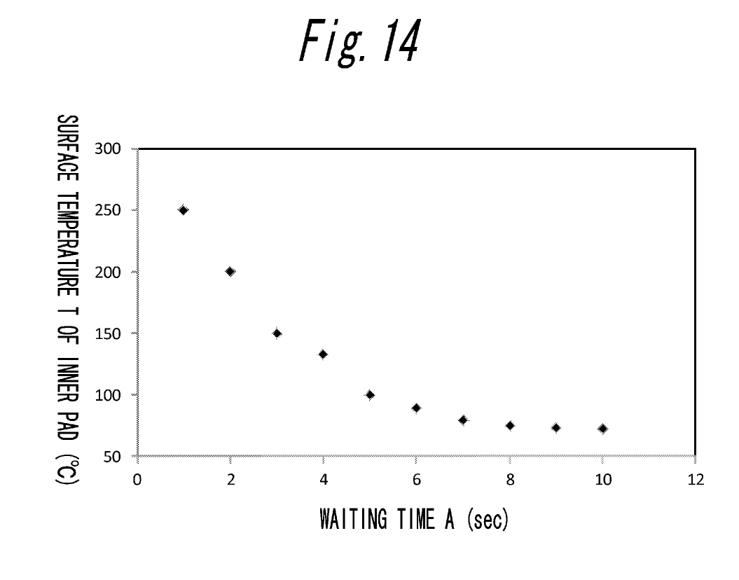

FIG. 14 is a graph illustrating a relationship between the waiting time A (a period of time from when the removal of the press-formed product 8 or 9 from the metal mold 2 or 3 is completed to when the next blank material 7 is set) and the surface temperature T of the inner pad top portion 231 or 331. Note that this waiting time A is a value calculated by using the aforementioned mathematical expression (3). As illustrated in FIG. 14, as the waiting time A becomes longer, the surface temperature T of the inner pad top portion 231 or 331 becomes lower. Further, in a range in which the waiting time A exceeds five seconds, the surface temperature T of the inner pad top portion 231 or 331 does not become low almost at all. As described above, it was confirmed that the waiting time A preferably satisfies the aforementioned mathematical expression (3) in which the lower limit is set to five seconds.

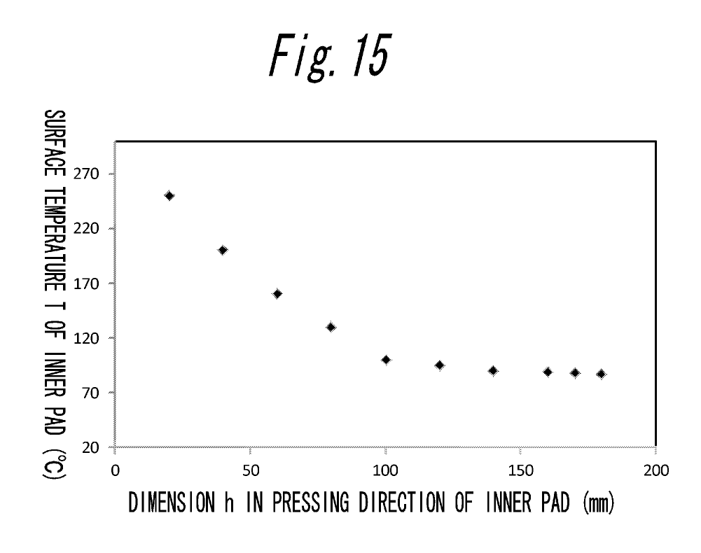

FIG. 15 is a graph illustrating a relationship between the dimension h in the pressing direction of the inner pad 23 or 33 and the surface temperature T of the inner pad top portion 231 or 331. Note that the measurement conditions are the same as the above-described conditions. Further, a value of the dimension h in the pressing direction is a value calculated by using the aforementioned mathematical expression (1). As the dimension h in the pressing direction of the inner pad 23 or 33 becomes larger, the surface temperature T of the inner pad top portion 231 or 331 becomes lower. Further, in a range in which the dimension h in the pressing direction of the inner pad 23 or 33 is 100 mm or more, the surface temperature T of the inner pad top portion 231 or 331 does not become low almost at all even when the dimension h in the pressing direction becomes large. As described above, it was confirmed that the dimension h in the pressing direction of the inner pad 23 or 33 preferably satisfies the aforementioned mathematical expression (1) in which the lower limit is set to 100 mm.

The embodiments of the present invention have been described above in detail while referring to the drawings. However, the above-described embodiments are merely exemplifications for implementing the present invention. The present invention can be implemented by appropriately changing the above-described embodiments within the scope which does not depart from the gist thereof, without being limited to the above-described embodiments.

### INDUSTRIAL APPLICABILITY

The present invention can be utilized for an industry related to a hot pressing system which executes a hot pressing method.

1. A hot pressing method, comprising
manufacturing a press-formed product by performing hot pressing on a blank material by using a metal mold having an upper die, a lower die, and an inner pad which is housed in the lower die in a movable manner and biased in a state of projecting toward the upper die, wherein:
a refrigerant path is provided inside the inner pad; and
by making a refrigerant flow through the refrigerant path, a surface temperature of the inner pad is cooled to a temperature satisfying the following mathematical expression in which an upper limit is set to 100° C., during a period from when removal of the press-formed product from the metal mold is completed to when the next blank material is set in the metal mold,
T≤100×(2.3/t)×(h/100)×(λ/30)×(W/2)×S
wherein
T: surface temperature of inner pad (° C.)
h: dimension in pressing direction of inner pad (mm)
t: thickness of blank material (mm)
λ: thermal conductivity of inner pad (W/mK)
W: volume ratio of refrigerant path inside inner pad (mm³/mm³)
S: flow rate of refrigerant in refrigerant path (mm/sec).

2. The hot pressing method according to claim 1, wherein
a period of time from when the removal of the press-formed product from the metal mold is completed to when the next blank material is set in the metal mold is set to a period of time satisfying the following mathematical expression in which a lower limit is set to five seconds,
A≥5×(t/2.3)×(100/h)×(30/λ)×(2/W)×(1/S)
wherein
A: period of time from when removal of press-formed product from metal mold is completed to when next blank material is set in metal mold (sec)
h: dimension in pressing direction of inner pad (mm)
t: thickness of blank material (mm)
λ: thermal conductivity of inner pad (W/mK)
W: volume ratio of refrigerant path inside inner pad (mm³/mm³)
S: flow rate of refrigerant in refrigerant path (mm/sec).

3. The hot pressing method according to claim 1, wherein
a dimension in a pressing direction of the inner pad satisfies the following mathematical expression in which a lower limit is set to 100 mm,
h≥100×(t/2.3)×(30/λ)×(2/W)×(1/S)
wherein
h: dimension in pressing direction of inner pad (mm)
t: thickness of blank material (mm)
λ: thermal conductivity of inner pad (W/mK)
W: volume ratio of refrigerant path inside inner pad (mm³/mm³)
S: flow rate of refrigerant in refrigerant path (mm/sec).

4. The hot pressing method according to claim 1, wherein
a fluid refrigerant is jetted to the inner pad to cool the inner pad during the period from when the removal of the press-formed product from the metal mold is completed to when the next blank material is set in the metal mold.

5. The hot pressing method according to claim 1, wherein:
the upper die is provided with a refrigerant jet hole capable of jetting the refrigerant toward the inner pad; and
during the period from when the removal of the press-formed product from the metal mold is completed to when the next blank material is set in the metal mold, the upper die is approximated to the lower die, and the refrigerant is jetted from the refrigerant jet hole toward the inner pad provided to the lower die to cool the inner pad.

6. A hot pressing system, comprising:
a press machine performing hot pressing on a blank material by using a metal mold having an upper die, a lower die, and an inner pad housed in the lower die in a movable manner, biased in a state of projecting toward the upper die, and having a refrigerant path provided therein; and
a cooling control unit controlling supply of a refrigerant which cools the inner pad, wherein
the cooling control unit makes the refrigerant flow through the refrigerant path to cool a surface temperature of the inner pad to a temperature satisfying the following mathematical expression in which an upper limit is set to 100° C., during a period from when removal of a press-formed product from the metal mold is completed to when the next blank material is set in the metal mold,
T≤100×(2.3/t)×(h/100)×(λ/30)×(W/2)×S
wherein
T: surface temperature of inner pad (° C.)
h: dimension in pressing direction of inner pad (mm)
t: thickness of blank material (mm)
λ: thermal conductivity of inner pad (W/mK)
W: volume ratio of refrigerant path inside inner pad (mm³/mm³)
S: flow rate of refrigerant in refrigerant path (mm/sec).

7. The hot pressing system according to claim 6, wherein
a period of time from when the removal of the press-formed product from the metal mold is completed to when the next blank material is set in the metal mold is set to a period of time satisfying the following mathematical expression in which a lower limit is set to five seconds,
A≥5×(t/2.3)×(100/h)×(30/λ)×(2/W)×(1/S)
wherein
A: period of time from when removal of press-formed product from metal mold is completed to when next blank material is set in metal mold (sec)
h: dimension in pressing direction of inner pad (mm)
t: thickness of blank material (mm)
λ: thermal conductivity of inner pad (W/mK)
W: volume ratio of refrigerant path inside inner pad (mm³/mm³)
S: flow rate of refrigerant in refrigerant path (mm/sec).

8. The hot pressing system according to claim 6, wherein
a dimension in a pressing direction of the inner pad satisfies the following mathematical expression in which a lower limit is set to 100 mm,
h≥100×(t/2.3)×(30/λ)×(2/W)×(1/S)
wherein
h: dimension in pressing direction of inner pad (mm)
t: thickness of blank material (mm)
λ: thermal conductivity of inner pad (W/mK)
W: volume ratio of refrigerant path inside inner pad (mm³/mm³)
S: flow rate of refrigerant in refrigerant path (mm/sec).

9. The hot pressing system according to claim 6, further comprising
a refrigerant jet part jetting the refrigerant to the inner pad, wherein
the refrigerant jet part jets a fluid refrigerant to the inner pad to cool the inner pad during the period from when the removal of the press-formed product from the metal mold is completed to when the next blank material is set in the metal mold.

10. The hot pressing system according to claim 6, wherein:
the upper die is provided with a refrigerant jet hole capable of jetting the refrigerant toward the inner pad; and
during the period from when the removal of the press-formed product from the metal mold is completed to when the next blank material is set in the metal mold, the press machine makes the upper die approximate to the lower die, and the cooling control unit jets the refrigerant from the refrigerant jet hole toward the inner pad provided to the lower die to cool the inner pad.
